(19) United States
(12) Patent Application Publication
(10) Pub. No.: US 2018/0016403 A1
(43) Pub. Date: Jan. 18, 2018

(54) METHOD FOR PREPARING NANO-PATTERN, AND NANO-PATTERN PREPARED THEREFROM

(71) Applicant: KOREA ADVANCED INSTITUTE OF SCIENCE AND TECHNOLOGY, Daejeon (KR)

(72) Inventors: Sang Ouk KIM, Daejeon (KR); Hyeong Min JIN, Daejeon (KR); Keon Jae LEE, Daejeon (KR); Seung Hyun LEE, Daejeon (KR); Ju Young KIM, Daejeon (KR)

(21) Appl. No.: 15/612,936

(22) Filed: Jun. 2, 2017

Related U.S. Application Data
(63) Continuation-in-part of application No. PCT/KR2015/013135, filed on Dec. 3, 2015.

(30) Foreign Application Priority Data
Dec. 3, 2014 (KR) 10-2014-0171871
Aug. 17, 2015 (KR) 10-2015-0115131
Nov. 9, 2016 (KR) 10-2016-0148810

(51) Int. Cl. C08J 3/28; B05D 1/00

(52) U.S. Cl. CPC C08J 3/28; B05D 1/005; C08J 2353/00; C08J 2383/10; C08J 2365/00

(57) ABSTRACT

Provided are a method for manufacturing a nano-pattern including: increasing a temperature of a self-assembling material applied on a substrate through light irradiation to form a self-assembly pattern, and a nano-pattern manufactured thereby. More particularly, the present invention relates to a method for manufacturing a nano-pattern capable of implementing various circuit patterns through simple dragging without using a photoresist pattern or chemical pattern in advance, implementing the nano-pattern on a substrate having a three-dimensional structure such as a flexible substrate as well as a flat substrate, and performing a process without a specific environmental restriction. In addition, the present invention relates to a method for manufacturing a nano-pattern capable of forming a large-area self-assembly pattern within a very short time, that is, several to several ten milliseconds (ms) by instantly irradiating high-energy flash light to instantly perform thermal annealing.

### CROSS-REFERENCE TO RELATED APPLICATIONS

The present application is a continuation-in-part of International Patent Application Serial No. PCT/KR2015/013135, entitled “SELF-ASSEMBLY NANOPATTERN MANUFACTURING METHOD USING LIGHT,” filed on Dec. 3, 2015. International Patent Application Serial No. PCT/KR2015/013135 claims priority to Korean Patent Application No. 10-2014-0171871, filed on Dec. 3, 2014; and to Korean Patent Application No. 10-2015-0115131, filed on Aug. 17, 2015. The present application also claims priority to Korean Patent Application No. 10-2016-0148810, filed on Nov. 9, 2016. The entire contents of each of the above-cited applications are hereby incorporated by reference in their entirety for all purposes.

### TECHNICAL FIELD

The present invention relates to a method for manufacturing a nano-pattern, and a nano-pattern manufactured thereby.

### BACKGROUND ART

Generally, in the case of applying sufficient energy to a block copolymer among raw materials used for self-assembly through annealing, phase separation occurs, thereby forming a nanostructure in which spheres, cylinders, lamellae, or the like, are periodically arranged. Since the nanostructure formed by the block copolymer is a thermodynamically stable structure, formation of the nanostructure spontaneously proceeds, and a shape and a size of the nanostructure may be easily adjusted by adjusting a relative composition ratio and a molecular weight of each block. Further, it is known that since formation of a block copolymer nanostructure proceeds in parallel, a mass production process may be applied thereto.

However, since energy is applied to an entire specimen in an annealing method according to the related art, there are disadvantages in that self-assembly of molecules is induced over an entire area, and it is impossible to allow self-assembly to selectively proceed only at a desired portion.

Some research into a technology of applying a zone annealing method for purifying a solid or manufacturing a single crystal to molecular self-assembly in order to overcome these disadvantages has been reported. The zone annealing method, which is also referred to as a zone melting method or zone refining method, is a method for heating and melting a bar-shaped solid (a metal, a semiconductor, or the like) using a ring-shaped heater having a narrow width to allow partial melting of the solid to occur in a narrow region, and moving the heater to slowly move a melting portion from one end of a bar-shaped test sample to the other end thereof.

For example, a study on molecular self-assembly induced from a block copolymer specimen using the zone annealing method has been conducted by Alamgir Karim Group from the National Institute of Standard and Technology (U.S.). Generally, when sufficient energy is applied to the block copolymer through annealing, molecules are self-assembled with each other by secondary weak force between the molecules. In this study, after forming a thermal gradient using a heating block having a centimeter (cm) size, a block copolymer cylinder aligned in one direction was obtained by passing the thermal gradient through the block copolymer specimen using a linear motor. As used herein, the term “thermal gradient”, which is a primary differential value of a temperature in a specific direction, means a temperature change rate from one point to another point, and is a value obtained by dividing a temperature difference between two points by a distance.

However, only a significantly low thermal gradient (about 17° C./mm) was implemented by the heating block. Therefore, there are problems in that a degree of alignment is not high enough to induce molecular self-assembly, particularly, it was more difficult to induce the molecular self-assembly to a selective region, and it was even more difficult to induce the molecular self-assembly to a three-dimensional substrate.

Meanwhile, as a method for inducing micro-phase separation in a manufacturing process of a nano-pattern using the block copolymer, a thermal annealing method, a solvent annealing method, or a combination thereof has been used. However, in these methods, since a long thermal treatment time is required, and a sample should be exposed at a high temperature for a long time, there is a disadvantage in that it takes a slightly long time for the process, and thus, a domain may be broken, or the sample may be modified. Further, since an annealing process should be performed under a vacuum or inert atmosphere, there was a problem in that process efficiency was low (Japanese Patent Laid-Open Publication No. 2015-129261.)

### RELATED ART DOCUMENT

### [Patent Document]

Japanese Patent Laid-Open Publication No. 2015-129261 (Jul. 16, 2015)

### DISCLOSURE

### Technical Problem

An object of the present invention is to provide a method for manufacturing a nano-pattern using self-assembly by applying a high temperature only to a portion irradiated with light using a photothermal conversion layer to induce self-assembly of molecules in a local portion.

Another object of the present invention is to provide a method for manufacturing a nano-pattern capable of having a significantly high thermal gradient through light irradiation, arbitrarily adjusting orientation of molecules, and improving a degree of orientation adjustment.

Another object of the present invention is to provide a method for manufacturing a pattern capable of forming a self-assembly pattern within a significantly short time, that is, several to several tens ms even under the air atmosphere, and a cross section pattern manufactured thereby.

### Technical Solution

In one general aspect, there is provided a method for manufacturing a nano-pattern including: increasing a temperature of a self-assembling material applied on a substrate through light irradiation to form a self-assembly pattern.

In a method for manufacturing a nano-pattern according to a first aspect of the present invention, directed self-assembly is induced after a complete disordered state is made by inducing χN (here, χ is a Flory-Huggins interaction parameter, and N is a degree of polymerization of a polymer in the self-assembling material) of the self-assembling material to be 10.5 or less in a region irradiated with light.

In a method for manufacturing a nano-pattern according to a second aspect of the present invention, a self-assembly pattern may be formed by irradiating light using a flash lamp annealing (FLA) type lamp.

In another general aspect, there are provided a nano-pattern manufactured by the method for manufacturing a nano-pattern as described above, and a semiconductor device including the nano-pattern.

### Advantageous Effects

According to the present invention, a method for manufacturing a nano-pattern by increasing a temperature of a self-assembling material through light irradiation, which is different from a method according to the related art in which molecular self-assembly should be isotropically induced on an entire substrate, is a novel method for manufacturing a pattern capable of selectively inducing molecular self-assembly in a local or entire region, particularly, selectively adjusting orientation, and improving a degree of orientation control.

Further, since this method does not require a specific environment but may be applied to a general environment (for example, room temperature and air atmosphere), it is not difficult to control a process, and thus it is possible to form a more stable nano-pattern without a complicated process. Therefore, in the case of adjusting and setting conditions such as the kind of substrate, a wavelength of light, a size of a focused region, an energy density, a light scan velocity, and the like, a significantly stable pattern with equal quality may be formed.

More specifically, in a method for manufacturing a nano-pattern according to a first aspect of the present invention, a significantly high thermal gradient may be obtained by partially irradiating light, and orientation of the self-assembling molecules may be arbitrarily adjusted by applying this thermal gradient to the annealing, and a degree of orientation adjustment may be improved. Further, regardless of a shape of the substrate, molecular self-assembly may be induced in a selective region by irradiating light even to a flexible or non-planar substrate.

In addition, various aligned patterns may be formed only in a selective region, and a nano-pattern formed as described above may be used to pattern transfer. Therefore, the method according to the present invention may be applied to a pattern process (pattern size<10 nm), which is a limitation of an existing semiconductor process, and various circuit patterns may be implemented by simple light irradiation without using a photoresist pattern or chemical pattern in advance.

Further, in a method for manufacturing a nano-pattern according to a second aspect of the present invention, a self-assembly pattern may be formed within a very short time, that is, several to several ten milliseconds (ms) even under the air atmosphere by annealing a self-assembling material using a flash lamp annealing (FLA) type lamp instantly emitting high energy.

In addition, there is an advantage in that as the light is irradiated in a pulse form, an annealing time may be adjusted in units of milliseconds by adjusting the number of pulse. Further, since the annealing time is significantly decreased, the self-assembling material is not chemically modified, such that the self-assembling material may maintain its unique characteristics, and light is instantly irradiated, such that only a self-assembly material layer may be selectively heated.

In addition, a nano-pattern having a large grain may be formed within a very short time, that is, several to several ten milliseconds (ms) by allowing χN of the self-assembling material to satisfy a suitable range.

Further, since the methods for manufacturing a nano-pattern according to the first and second aspects of the present invention do not require a specific environment, and a manufacturing process is not complicated, molecular self-assembly may be more stably induced.

### DESCRIPTION OF DRAWINGS

FIG. 1 is a view schematically illustrating a method for manufacturing a nano-pattern capable of locally inducing molecular self-assembly on a substrate on which a photothermal conversion layer is formed through light irradiation.

FIG. 2 is a graph illustrating a temperature of a substrate at the time of light irradiation depending on a light energy density of the substrate according to Example 1.

FIG. 3 is scanning electron microscope images obtained by observing the substrate according to Example 1.

FIGS. 4A, 4B and 4C are images illustrating degrees of molecular self-assembly alignment of substrates according to Examples 1 and 2 depending on a light scan velocity.

FIG. 5 is scanning electron microscope images obtained by observing substrates according to Examples 1, 4, and 5.

FIGS. 6 and 7 are views obtained by observing a substrate according to Example 10 using an atomic force microscope (AFM), wherein FIG. 6 is a two-dimensional image, and FIG. 7 is a three-dimensional image. In FIGS. 6 and 7, left images are images of a mixed poly(3-hexylthiophene/(6,6)-phenyl-C61-butyric acid methyl ester (P3HT/PCBM) thin film substrate before laser irradiation, and right images are images of a mixed P3HT/PCBM thin film in which molecular self-assembly is induced by laser irradiation.

FIG. 8 is a scanning electron microscope image obtained by observing molecular self-assembly alignment of polystyrene-block-poly(2-vinylpyridine) according to Example 8.

FIG. 9 is a scanning electron microscope image obtained by observing molecular self-assembly alignment of polystyrene-block-polydimethylsiloxane according to Example 9.

FIG. 10 is a scanning electron microscope image obtained by observing a substrate in which molecular self-assembly is induced in a selective region including a fine portion according to Example 1.

FIGS. 11A and 11B are scanning electron microscope images obtained by observing substrates according to Example 1 and Comparative Example 1, wherein FIG. 11A is an image illustrating a substrate to which a general thermal annealing is applied according to Comparative Example 1, and FIG. 11B is an image of a substrate in which molecular self-assembly is induced by light irradiation according to Example 1.

FIG. 12 is a graph illustrating a temperature (° C.) and a thermal gradient depending on a distance (mm) when molecular self-assembly is induced by irradiating light to the substrate according to Example 1.

FIG. 13 illustrates a schematic example of a method for manufacturing a nano-pattern using self-assembly according to the present invention.

FIG. 14 is a flow chart illustrating the schematic example of the method for manufacturing a nano-pattern using self-assembly according to the present invention.

FIGS. 15 to 18 are scanning electron microscope (SEM) images and schematic views illustrating examples of the method for manufacturing a nano-pattern using self-assembly depending on the kind and shape of substrate.

FIGS. 19 and 20 illustrate a temperature gradient of a photothermal conversion layer at the time of light irradiation according to Example 1 using a thermo-graphic camera (T400, manufactured by Flir Systems Inc., U.S.).

FIG. 21 is SEM images and a graph illustrating an example of pattern formation depending on time and energy density in Example 2.

FIGS. 22 to 24 are SEM images and graphs illustrating an example of pattern formation depending on a light scan velocity in Example 3.

FIG. 25 illustrates an orientation order parameter according to a light scan velocity.

FIG. 26 illustrates a correlation length depending on a reciprocal of the light scan velocity.

FIG. 27 are a graph and SEM images illustrating an example of pattern formation depending on a scanning time and temperature in Examples 1 to 3.

FIGS. 28A, 28B, and 28C are views illustrating a method for forming a block copolymer self-assembly pattern by irradiating light using a FLA type lamp according to an exemplary embodiment of the present invention, wherein FIG. 28A is a view illustrating a method for irradiating light to a block copolymer using the FLA type lamp, FIG. 28B is a graph illustrating a temperature change of the block copolymer depending on time at the time of irradiating light once (1 pulse, 15 ms), and FIG. 28C is an air view of a thermographic image obtained by calculating the increase in temperature of the block copolymer by a photothermal effect.

FIG. 29 is scanning electron microscope (SEM) photographs of patterns manufactured according to Examples 13 to 15 and Comparative Examples 5 to 7.

FIGS. 30A, 30B, 30C, and 30D are SEM photographs of patterns manufactured according to Examples 17 to 19 and Comparative Example 8.

FIGS. 31A, 31B, and 31C are SEM photographs illustrating a pattern change depending on a light irradiation time according to Example 20.

FIGS. 32A, 32B, 32C, 32D, 32E, and 32F are SEM photographs illustrating a pattern change depending on a light irradiation intensity according to Example 21.

FIGS. 33A, 33B, and 33C are SEM photographs illustrating a degree of damage of the block copolymer depending on a thermal annealing time according to Comparative Example 9.

FIGS. 34A and 34B are SEM photographs illustrating pattern formation of a block copolymer having a high χN value according to Example 16. FIGS. 34A and 34B illustrate that when a general thermal annealing method is used (FIG. 34A) and a flash lamp anneal (FLA) method is used (FIG. 34B), a pattern is not suitably formed in both of the methods.

FIG. 35A illustrates data obtained by measuring a disclination change depending on an annealing time and a χN value of a block copolymer in flash lamp annealing (FLA) according to the present invention and thermal annealing, FIG. 35B illustrates data obtained by measuring an atomic content (at %) depending on FLA and thermal annealing conditions, FIG. 35C illustrates X-ray photoelectron spectroscopy (XPS) data of a block copolymer depending on FLA and thermal annealing conditions, FIG. 35D illustrates a block copolymer equally divided into 16 regions (size: 2 cm×2 cm), and FIG. 35E illustrates data obtained by counting the number of disclinations in each region and calculating an average distance (nm) of the disclinations (hereinafter, inter-disclination distance (nm)). As a result of XPS analysis, it may be appreciated that thermal degradation is decreased in the flash lamp annealing (FLA) as compared to general thermal annealing (at 200° C. for 12 hours under vacuum and at 200° C. for 100 seconds under the air atmosphere).

### DETAILED DESCRIPTION OF MAIN ELEMENTS

1: Non-self-assembling molecule
2: Self-assembling molecule
3: Photothermal conversion layer
4: Substrate
5: Light

### BEST MODE

Hereinafter, a method for manufacturing a nano-pattern according to the present invention, and a nano-pattern manufactured thereby will be described in detail with reference to the accompanying drawings. The following accompanying drawings are provided by way of example so that the idea of the present invention can be sufficiently transferred to those skilled in the art to which the present invention pertains. Therefore, the present invention is not limited to the drawings to be provided below, but may be modified in different forms. In addition, the drawings to be provided below may be exaggerated in order to clarify the scope of the present invention. In addition, like reference numerals denote like elements throughout the specification.

Here, technical terms and scientific terms used in the present specification have the general meaning understood by those skilled in the art to which the present invention pertains unless otherwise defined, and a description for the known function and configuration unnecessarily obscuring the gist of the present invention will be omitted in the following description and the accompanying drawings.

In addition, in describing components of the present invention, terms such as first, second, A, B, (a), (b), etc., can be used. These terms are used only to differentiate the components from other components. Therefore, the nature, times, sequence, etc., of the corresponding components are not limited by these terms. When any components are “connected”, “coupled”, or “linked” to other components, it is to be noted that the components may be directly connected or linked to other components, but the components may be “connected”, “coupled”, or “linked” to other components via another component therebetween.

As used herein, the term “orientation order parameter (Ψ)” indicates a degree at which two or more patterns having a linear shape are aligned in one direction, and when the patterns are perfectly aligned in one direction, orientation order parameter (Ψ) is 1 (Ψ=1).

As used herein, the term “correlation length” indicates to what degree respective patterns are correlated with each other in some patterns, and is to indirectly measure a domain size of a pattern, and a correlation length of a pattern having a perfectly aligned lamellar shape is close to infinity.

Hereinafter, a method for manufacturing a local nano-pattern will be described in detail as a first aspect of the present invention, and a method for manufacturing a large-area nano-pattern will be described in detail as a second aspect of the present invention.

Here, it should be interpreted that in describing the present invention, if contents are not specifically confined to the first aspect, the second aspect, or the like, (for example, if contents are confined to an exemplary embodiment of the present invention), description of the corresponding contents may be applied to all aspects derived from any one or a combination or two or more of various aspects. Here, for more clear understanding, these contents applied to all aspects derived from any one and/or a combination or two or more of various aspects may be collectively referred to and described as a general aspect.

A method for manufacturing a nano-pattern according to the general aspect of the present invention may include: increasing a temperature of a self-assembling material applied on a substrate through light irradiation to form a self-assembly pattern.

The method for manufacturing a nano-pattern by increasing the temperature of the self-assembling material through light irradiation, which is different from a method according to the related art in which molecular self-assembly should be isotropically induced over an entire substrate, is a novel method for manufacturing a pattern capable of selectively inducing molecular self-assembly in a local or entire region, particularly, selectively adjusting orientation, and improving a degree of orientation adjustment.

Further, since this method does not require a specific environment but may be applied to a general environment (for example, at room temperature under the air atmosphere), it is not difficult to control a process, and thus a more stable nano-pattern may be formed without a complicated process. Therefore, in the case of adjusting and setting conditions such as the kind of substrate, a wavelength of light, a size of a focused region, an energy density, a light scan velocity, and the like, a significantly stable pattern with equal quality may be formed.

It was found that a disordered state was instantly made in a light irradiation region by irradiating light while adjusting the conditions such as the wavelength of light, a size of a region to be irradiated with light, the energy density, the light scan velocity, and the like, as described above, and maintaining a χN value of a polymer thin film to be irradiated within a specific range, and thus a pattern was significantly quickly and naturally formed.

More specifically, in the method for manufacturing a nano-pattern according to a general aspect of the present invention, the substrate may further include a photothermal conversion layer on the substrate. That is, the method for manufacturing a nano-pattern according to an exemplary embodiment of the present invention may include: a) forming a photothermal conversion layer on a substrate; b) forming a polymer layer by applying a self-assembling material containing a polymer on the photothermal conversion layer; and c) forming a nano-pattern by irradiating light to the polymer layer and performing self-assembly.

First, the photothermal conversion layer used in the method for manufacturing a nano-pattern as described above is to convert light energy transferred by light irradiation into heat energy and transfer the heat energy to induce self-assembly of the polymer layer, and it is preferable that the photothermal conversion layer is made of a material having a large light absorption coefficient and excellent heat transfer characteristics.

In the present invention, the photothermal conversion layer may be made of any material as long as the material has excellent heat transfer characteristics. As an example, the photothermal conversion layer may have a light absorption coefficient larger than that of the polymer layer and have a reflection coefficient smaller than that of the polymer layer. Further, although not limited, a light absorption rate of the photothermal conversion layer may be 0.001 to 99.99%, preferably, 0.01 to 99.99%, more preferably, 10 to 99.99%, and most preferably, 20 to 99.9%.

In addition, an average particle size of the photothermal conversion layer may be 5 to 500 nm. Within the above-mentioned range, photothermal conversion efficiency may be maximized. The term “average particle size” means “an average value of particle sizes of the photothermal conversion layer”.

In the present invention, a constituent material of the photothermal conversion layer is not limited, but may include one or two or more selected from graphene, graphene oxide, reduced graphene oxide, carbon nanotube, carbon black, amorphous carbon, a metal thin film, a metal oxide thin film, and a transition metal chalcogenide thin film. Particularly, since it is preferable to use a material having mechanically excellent durability in the photothermal conversion layer, it is preferable to use graphene which has a honeycomb lattice and is a one-atom-thick planar sheet of carbon atoms, or chemically modified graphene (CMG), that is, reduced graphene oxide. Since the reduced graphene oxide is significantly thin, absorbs light well, and has low thermal conductivity unlike graphene using a chemical vapor deposition (CVD) method, photothermal conversion efficiency thereof is significantly high. However, the present invention is not limited thereto, but any material as well as the above-mentioned materials may be used without limitation as long as it has a high light absorption coefficient.

In the present invention, a case in which the reduced graphene oxide is used is illustrated in FIG. 14. As illustrated in FIG. 14, the reduced graphene oxide may be smoothly applied to an uneven substrate or flexible substrate, and after the polymer layer is formed by coating the block copolymer thereon, self-assembly may be induced by irradiating light.

In the present invention, the photothermal conversion layer may further contain a dye (for example, a visible dye, a UV dye, an IR dye, a fluorescent dye, a radiation polarizing dye, and the like), a pigment, a metal, a metal compound, a metal film, a metal oxide, a metal sulfide, and the like in addition to the above-mentioned carbon material. Further, a UV curable resin, a multifunctional monomer, an initiator, a solvent, an additive, or a mixture thereof, etc., may be mixed together to thereby be used.

In the present invention, the dye and pigment are not limited as long as the dye and pigment may convert absorbed light energy at the time of light irradiation to heat energy. For example, the dye or pigment may be selected from the group consisting of a diammonium based dye, a metal complex based dye, a naphthalocyanine based dye, a phthalocyanine based dye, a polymethine based dye, an anthraquinone based dye, a porphyrin based dye, a cyanine based dye having a metal-complex shape, a carbon black pigment, a metal oxide pigment, a metal sulfide pigment, a graphite pigment, and a mixture thereof.

Meanwhile, as the thickness of the photothermal conversion layer is decreased, light absorption is decreased, and as the thickness of the photothermal conversion layer is increased, heat transfer is decreased. Therefore, it is preferable that the thickness of the photothermal conversion layer is limited in a suitable range in which light absorption and heat transfer are smoothly performed. As an example, the photothermal conversion layer may have a thickness of 0.2 nm to 1 cm, preferably, 1 nm to 1 mm, and more preferably, 10 to 300 nm. Further, a shape of the photothermal conversion layer laminated on a surface of the substrate and having an upper surface on which the polymer layer is laminated may be freely changed depending on a shape of the substrate, and the present invention is not limited thereto.

In the present invention, the substrate, which serves to support the photothermal conversion layer and the polymer layer, may be disposed on a surface of the photothermal conversion layer opposing a surface of the photothermal conversion layer on which the polymer layer is disposed. The kind and shape of substrate are not limited as long as the substrate may be used for applying a polymer and forming a thin film. As an example, the substrate may have a wafer or film shape, and in physical view, the substrate may be a rigid substrate or flexible substrate. In crystallographic view, the substrate may be a single crystalline phase, a polycrystalline phase, or an amorphous phase, or be a mixed phase of a crystalline phase and an amorphous phase. In the case in which the substrate is a laminate substrate in which two or more layers are laminated, the layers are each independently a single crystalline phase, a polycrystalline phase, an amorphous phase, or a mixed phase thereof. Physically, the substrate may be an inorganic substrate, an organic substrate, or a laminate substrate in which inorganic and organic substrates are mixed, but is not particularly limited as long as the substrate may basically absorb light. In the case in which light is not absorbed in a substrate but passes through the substrate, a temperature of a self-assembling material is not increased, such that it may be impossible to form a nano-pattern. Therefore, when the substrate is an opaque substrate, the kind of opaque substrate is not particularly limited, and any opaque substrate may be used. When the substrate is a transparent substrate, the substrate may be used in a state in which the photothermal conversion layer is provided on the substrate.

A non-restrictive example of the inorganic substrate may include a laminate substrate in which two or more materials selected from glass; a group 4 semiconductor material including silicon (Si), germanium (Ge), or silicon germanium (SiGe); a group 3-5 semiconductor material including gallium arsenide (GaAs), indium phosphorus (InP), or gallium phosphorus (GaP); a group 2-6 semiconductor material including cadmium sulfide (CdS), zinc telluride (ZnTe); a group 4-6 semiconductor material including lead sulfide (PbS); and an oxide thereof are laminated while forming layers, respectively, but is not limited thereto.

The organic substrate may be made of one or more materials selected from polyethyleneterephthalate (PET), polyethylenenaphthalate (PEN), polymethylmethacrylate (PMMA), polyetheretherketone (PEEK), polycarbonate (PC), polyimide (PI), polyethersulfone (PES), polyarylate (PAR), and cyclo olefin (COC) and a shape of the organic substrate is not limited. For example, the organic substrate may have a curved shape, an edge shape, an irregular shape, or the like. In addition, formation of the nano-pattern is not affected by a thickness of the substrate, or the like.

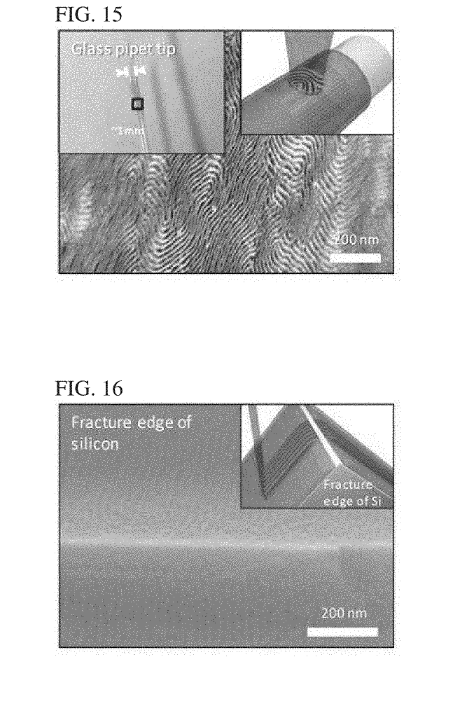

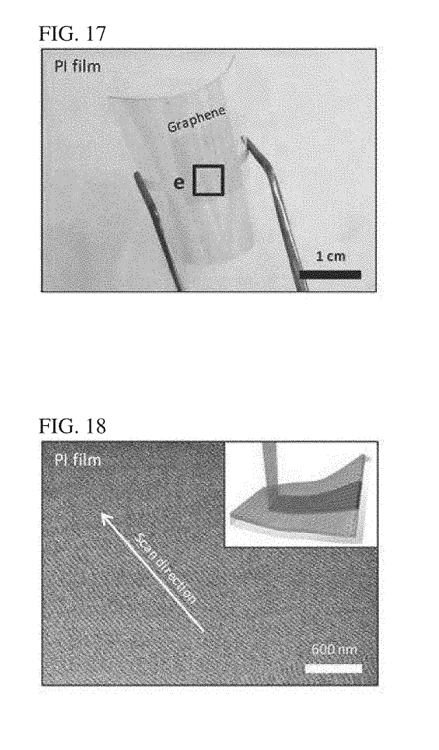

For example, FIGS. 15 to 18 illustrate results of measuring formation of patterns depending on a shape of a substrate (FIG. 15: glass pipet, FIG. 16: edge of silicon, FIG. 17: polyimide film (curved), and FIG. 18: polyimide film (irregular surface)) using a scanning electron microscope (SEM), and it may be appreciated that a constant and uniform pattern is formed regardless of the shape of the substrate as illustrated in FIGS. 15 to 18.

Next, the forming of the polymer layer may be performed by applying of the self-assembling material on the substrate on which the photothermal conversion layer is formed. Here, it is preferable to suitably select physical properties of the self-assembling material, or the like, depending on a light irradiation method to be used. A more detailed description thereof will be described in first and second aspects to be described below, and in the general aspect, the kind of self-assembling material will be described.

In the present invention, the self-assembling material may be made of a polymer alone, or a mixture of polymer and any one or two or more selected from an organic compound including any one or two or more selected from a liquid crystal forming compound, an organic semiconductor compound, and an organic photoelectronic compound; a conjugated polymer including any one or more selected from a liquid crystal forming polymer, an organic semiconductor polymer, and an organic photoelectronic polymer; and a reducing agent of Flory-Huggins interaction parameter (χ).

The polymer may be a block copolymer capable of forming a pattern through self-assembly. The block copolymer commonly indicates a polymer in which two or more unit blocks having different structures or properties from each other are bound to each other through a covalent bond to form a single polymer, and the respective unit blocks forming the block copolymer have different physical properties and selective solubility from each other due to difference in chemical structure between the respective unit blocks. This is a cause of formation of a self-assembled structure by phase separation or selective dissolution of the block copolymer in a solution phase or solid phase.

The block copolymer forms a micro structure having a specific shape through self-assembly, which is affected by physical/chemical characteristics of the unit blocks. In a block copolymer existing in a thin film state on a substrate, when a temperature is equal to or higher than a glass transition temperature, a polymer chain has flowability, such that in order to minimize free energy by interfacial and surface interactions between the substrate and the block copolymer, a nanostructure is formed by self-assembly and arranged on the substrate with a specific pattern. In this case, when one side block has a selective interaction with the substrate, orientation of the nanostructure parallel with the substrate may occur. Further, orientation may be adjusted to be parallel with or perpendicular to the substrate by adjusting the surface interaction between the substrate and the block copolymer, and thus, it is possible to form a uniform pattern.

For example, in the case in which a diblock copolymer composed of two different structures is self-assembled in a bulk substrate, a volume fraction between respective unit blocks configuring the block copolymer is primarily affected by a molecular weight of each of the unit blocks. The self-assembled structure of the block copolymer is determined to be any one of various structures such as a cubic and double gyroid structures, which are three-dimensional structures, a hexagonal packed column structure and a lamellar structure, which are two-dimensional structures, and the like, depending on the volume fraction between two unit blocks. Here, a size of each of the unit blocks in each of the structures is in proportion to the molecular weight of the corresponding unit block.

The block copolymer according to the present invention may include a block copolymer formed by polymerizing at least one hydrophilic unit block and at least one hydrophobic unit block with each other. Here, when a molecular weight of the entire block copolymer is 100, a molecular weight ratio between the respective unit blocks may be preferably 20:80 to 80:20 (hydrophilic unit block: hydrophobic unit block).

As an example, when the molecular weight ratio between the respective unit blocks is 50:50, a plate-shaped (lamellar) nanostructure with a patterned structure may be formed, and when the molecular weight ratio between the respective unit blocks is 70:30, a cylindrical nanostructure with a patterned structure may be formed. Further, depending on a composition ratio, a gyroid or spherical nanostructure may be formed, but the present invention is not limited thereto.

In detail, it is advantageous that the block copolymer or a graft copolymer has blocks each having different physical properties so as to be self-assembled with each other, and examples of the physical properties may include hydrophilicity/hydrophobicity, polarity/non-polarity, an ionic property/non-ionic property, water-solubility/water-insolubility, and the like, but are not limited thereto as long as physical properties of respective blocks are different from each other so that the copolymer may be self-assembled.

As an example, the block copolymer according to the present invention includes at least two different repeating units selected from polyurethane, an epoxy polymer, polyarylene, polyamide, polyester, polycarbonate, polyimide, polysulfone, polysiloxane, polysilazane, polyether, polyurea, polyolefin, a vinyl based addition polymer, and an acrylic polymer. As a specific example, the block copolymer may be a block copolymer or graft copolymer including a hydrophilic acrylic block and a hydrophobic acrylic block; a hydrophilic alkyleneoxide block and a hydrophobic alkyleneoxide block; a vinyl based aromatic block and a hetero atom-substituted vinyl based aromatic block; a hetero atom-substituted or unsubstituted vinyl based aromatic block and an acrylic block; a hetero atom-substituted or unsubstituted vinyl based aromatic block and an alkyleneoxide block; and a polyester based block and an acrylic block; a polysiloxane block and a polysulfone block; a polysiloxane block and an alkyleneoxide block; a polysiloxane block and an acrylic block; a polysiloxane block and a polyimide based block; a polycarbonate block and a polysiloxane block; a polyester block and a polyether block; a polyamide block and a polyether block; or the like, but is not limited thereto. The blocks used in the copolymer for self-assembly are not limited as long as these bocks have different chemical and/or physical properties from each other.

As a non-restrictive example of the block copolymer, any one or two or more selected from the group consisting of polystyrene-block-polymethylmethacrylate, polybutadiene-block-polybutylmethacrylate, polybutadiene-block-polydimethylsiloxane, polybutadiene-block-polymethylmethacrylate, polybutadiene-block-polyvinylpyridine, polybutylacrylate-block-polymethylmethacrylate, polybutylacrylate-block-polyvinylpyridine, polyisoprene-block-polyvinylpyridine, polyisoprene-block-polymethylmethacrylate, polyhexylacrylate-block-polyvinylpyridine, polyisobutylene-block-polybutylmethacrylate, polyisobutylene-block-polymethylmethacrylate, polyisobutylene-block-polybutylmethacrylate, polyisobutylene-block-polydimethylsiloxane, polybutylmethacrylate-block-polybutylacrylate, polyethylethylene-block-polymethylmethacrylate, polystyrene-block-polybutylmethacrylate, polystyrene-block-polybutadiene, polystyrene-block-polyisoprene, polystyrene-block-polydimethylsiloxane, polystyrene-block-polyvinylpyridine, polyethylethylene-block-polyvinylpyridine, polyethylene-block-polyvinylpyridine, polyvinylpyridine-block-polymethylmethacrylate, polyethyleneoxide-block-polyisoprene, polyethyleneoxide-block-polybutadiene, polyethyleneoxide-block-polystyrene, polyethyleneoxide-block-polymethylmethacrylate, polyethyleneoxide-block-polydimethylsiloxane, polystyrene-block-polyethyleneoxide, polystyrene-block-polymethylmethacrylate-block-polystyrene, polybutadiene-block-polybutylmethacrylate-block-polybutadiene, polybutadiene-block-polydimethylsiloxane-block-polybutadiene, polybutadiene-block-polymethylmethacrylate-block-polybutadiene, polybutadiene-block-polyvinylpyridine-block-polybutadiene, polybutylacrylate-block-polymethylmethacrylate-block-polybutylacrylate, polybutylacrylate-block-polyvinylpyridine-block-polybutylacrylate, polyisoprene-block-polyvinylpyridine-block-polyisoprene, polyisoprene-block-polymethylmethacrylate-block-polyisoprene, polyhexylacrylate-block-polyvinylpyridine-block-polyhexylacrylate, polyisobutylene-block-polybutylmethacrylate-block-polyisobutylene, polyisobutylene-block-polymethylmethacrylate-block-polyisobutylene, polyisobutylene-block-polybutylmethacrylate-block-polyisobutylene, polyisobutylene-block-polydimethylsiloxane-block-polyisobutylene, polybutylmethacrylate-block-polybutylacrylate-block-polybutylmethacrylate, polyethylethylene-block-polymethylmethacrylate-block-polyethylethylene, polystyrene-block-polybutylmethacrylate-block-polystyrene, polystyrene-block-polybutadiene-block-polystyrene, polystyrene-block-polyisoprene-block-polystyrene, polystyrene-block-polydimethylsiloxane-block-polystyrene, polystyrene-block-polyvinylpyridine-block-polystyrene, polyethylethylene-block-polyvinylpyridine-block-polyethylethylene, polyethylene-block-polyvinylpyridine-block-polyethylene, polyvinylpyridine-block-polymethylmethacrylate-block-polyvinylpyridine, polyethyleneoxide-block-polyisoprene-block-polyethyleneoxide, polyethyleneoxide-block-polybutadiene-block-polyethyleneoxide, polyethyleneoxide-block-polystyrene-block-polyethyleneoxide, polyethyleneoxide-block-polymethylmethacrylate-block-polyethyleneoxide, polyethyleneoxide-block-polydimethylsiloxane-block-polyethyleneoxide, and polystyrene-block-polyethyleneoxide-block-polystyrene may be used, but the block copolymer is not limited thereto. Any block copolymer as well as the above-mentioned block copolymers may be used without limitation as long as it may form a self-assembled structure.

In the present invention, the organic compound or conjugated polymer is used for molecular self-assembly and domain formation through thermal annealing, and photoelectric characteristics, luminescence, electrical properties, device stability, or the like, of the manufactured nano-pattern and a semiconductor device including the same may be improved depending on molecular self-assembly and domain formation.

In the present invention, the organic compound may include an aromatic group having a number average molecular weight of 2,000 or less. As an example, the organic compound may include any one or two or more selected from a liquid crystal forming compound, an organic semiconductor compound, and an organic photoelectronic compound. Here, the liquid crystal forming compound may mean a compound orientated in a constant direction by self-assembly to have liquid crystal characteristics, the organic semiconductor compound may mean a compound having semiconducting characteristics, and the organic photoelectronic compound, which is a compound used in an organic photoelectronic device, may mean a compound capable of performing a light emission, electron injection or electron transport function.

More specifically, in the exemplary embodiment of the present invention, examples of the organic compound may include (6,6)-phenyl-C61-butyric acid methyl ester (PCBM); pentacene; 6,13-bis(triisopropylsilylethynyl)pentacene (TIPS-pentacene); tetracene; hexathiapentacene (HTP); 1-cyanotrans-1,2-bis-(3′,5′-bis-trifluoromethyl-biphenyl)ethylene (CNTFMBE); anthracene; naphthalene diimide; perylene; rubrene; coronene; perylenetetracarboxylic diimide; perylene tetracarboxylicdianhydride; thiophene or an oligomer thereof; benzothiazole or an oligomer thereof; fluorene; oligoacene of naphthalene; phthalocyanine containing or not-containing a metal; pyromellitic dianhydride; pyromellitic diimide; 4-cyano-4′-pentylbiphenyl (5CB); 4-cyano-4′-hexylbiphenyl (6CB); 4-cyano-4′-heptylbiphenyl (7CB); 4-cyano-4′-octylbiphenyl (8CB); hexakis [pentyloxy]-triphenylene (HAT-5); (S)-4′-octyloxy-biphenyl-4-carboxylic acid 4-(1-methyl-heptyloxycarbonyl)-phenyl ester ((S)-MHPOBC); N,N′-bis(2-phenylethyl)-perylene-3,4:9,10-tetracarboxylic diimide (BPE-PTCDI); 1,5-diaminoanthraquinone (DAAQ); 5,10,15,20-tetra(4-pyridyl)-porphyrin (H2TPyP); N,N′-dioctyl-3,4,9,10-perylenedicarboximide; and derivatives of these compounds. However, as long as it may induce molecular self-assembly, the organic compound is not particularly limited and may be selected depending on use purposes or characteristics to be desired.

The conjugated polymer may include a material having a molecular weight larger than that of the organic compound, for example, any one or more selected from a liquid crystal forming polymer, an organic semiconductor polymer, and an organic photoelectronic polymer. Here, the liquid crystal forming polymer may mean a polymer orientated in a constant direction by self-assembly to have liquid crystal characteristics, the organic semiconductor polymer may mean a polymer having semiconducting characteristics, and the organic photoelectronic polymer, which is a polymer used in an organic photoelectronic device, may mean a polymer capable of performing a light emission, electron injection or electron transport function.

More specifically, in the exemplary embodiment of the present invention, the conjugated polymer may be a conjugated polymer including one or at least two repeating units induced from quinoline, quinoxaline, phenylene, phenylenevinylene, phenylenesulfide, fluorene, pyridine, pyridylvinylene, pyrrole, aniline, thiophene, alkylthiophene, thiophenevinylene, furan, acetylene, quinone, carbazole, azulene, indole, and derivatives of these compounds.

In detail, examples of the conjugated polymer may include polyquinoline, polyquinoxaline, polyphenylene, polyphenylenevinylene, polyphenylenesulfide, polyfluorene, polypyridine, polypyridylvinylene, polypyrrole, polyaniline, polythiophene, polyalkylthiophene, polythiophenevinylene, polyfuran, polyacetylene, polyquinone, polycarbazole, polyazulene, polyindole, poly[(9,9-dioctylfluorenyl-2,7-diyl)-co-bithiophene] (F8T2), poly[bis(4-phenyl)(2,4,6-trimethylphenyl)amine] (PTAA), poly(2,5-bis(3-hexadecylthiophen-2-yl)thieno[3,2-b]thiophene) (pBTTT), polystyrene-b-poly(perylene bisimideacrylate) (PS-b-PPerAcr), poly(bis(4-methoxyphenyl)-4′-vinylphenylamine)-b-Poly(perylene bisimide acrylate) (PS-b-PPerAcr), poly(vinyl triphenylamine), derivatives thereof, and polymers including two or more selected thereof.

Further, in the present invention, the self-assembling material may include a reducing agent of Flory-Huggins interaction parameter in addition to the polymer. The reducing agent of Flory-Huggins interaction parameter (χ), which serves to reduce a χN value in the polymer layer, may allow the self-assembling material to have a suitable χN value by a light irradiation method to be described below.

In the present invention, the reducing agent of Flory-Huggins interaction parameter (χ) may be any one or two or more selected from a random copolymer, a block oligomer, surface-treated inorganic particles, and a solvent, but any material as well as the above-mentioned materials may be used regardless of the kind of material as long as the material may reduce a χN value, and this is also included in the scope of the present invention.

In the present invention, χN, which is a factor determining whether or not the block copolymer is self-assembled, is calculated by multiplying Flory-Huggins interaction parameter (χ) by a degree of polymerization (N) of the block copolymer. However, the Flory-Huggins interaction parameter (χ) is a value changed depending on the kind and a molecular weight of polymer, the kind of solvent, a temperature, a crosslinking structure, and the like.

In the present invention, the Flory-Huggins interaction parameter (χ) may be calculated using the following Calculation Equation 1.

$$𝒳 ≅ \frac{V}{RT} {( {δ}_{1} - {δ}_{2} )}^{2} \qquad [ Calculation Equation 1 ]$$

In Calculation Equation 1, V is a volume of a composition, R is a gas constant, T is a temperature of the composition, δ is a solubility parameter (δ₁: solubility parameter of the block copolymer, and δ₂ is a solubility parameter of the reducing agent of Flory-Huggins interaction parameter (χ). Further, the solubility parameter is a value obtained by dividing a sum of molar attraction constants (F) of respective components according to a group contribution method by a molar volume.

In a diblock copolymer of which two blocks are symmetrical to each other in a block copolymer thin film generally manufactured to contain a solvent, or the like, according to the thermodynamic theory, when χN is 10.5 or more, micro phase separation occurs (C. Park, J. Yoon, and E. L. Thomas, Polymer, 44/22, 6725(2003)). At the time of the micro phase separation as described above, a block copolymer is oriented in various structures such as a lamellar structure, a double gyroid structure, a cylindrical structure, a body centered cubic structure, and the like, depending on a volume fraction of each of the blocks, and a variety of these structures may be connected to a variety of self-assembled micro structures.

However, as described above, in the self-assembled micro structure, at the time of orientation of nano domains, an orientation direction may be disordered, and various defects may be formed. Therefore, generally, when a defect is formed, a pattern including the defect may be fixed, such that it may be difficult to change a shape any further. A disordered state may be induced by further adding the reducing agent of Flory-Huggins interaction parameter (χ) to instantly reduce the χN value in a region irradiated with light in order to solve this problem. Here, the reducing agent of Flory-Huggins interaction parameter (χ) serves to instantly induce a state of the block copolymer in a portion irradiated with light to the disordered state to naturally form a pattern of the block copolymer.

As a specific example of the reducing agent of Flory-Huggins interaction parameter (χ), the random copolymer, which means a polymer in which two or more monomers are polymerized without regularity in arrangement, is a concept in contrast to the block copolymer. That is, at the time of measuring a glass transition temperature (Tg), while the block copolymer has the same number of glass transition temperatures (Tg) as the number of monomers, and is not uniform as compared to the random copolymer, the random copolymer has a single glass transition temperature (Tg), and a manufacturing process thereof is simpler. Further, in the present invention, the random copolymer has a molecular weight smaller than that of the block copolymer.

In the present invention, a repeating unit, a polymerization method, and the like, of the random copolymer are not limited as long as the object of the present invention may be achieved. The random copolymer may further include one or more repeating units selected from polyurethane, an epoxy polymer, polyarylene, polyamide, polyester, polycarbonate, polyimide, polysulfone, polysiloxane, polysilazane, polyether, polyurea, polyolefin, a vinyl based addition polymer, and an acrylic polymer as an example of the repeating unit. Here, the number of repeating unit is one or more, which includes various chemical forms of the repeating units. For example, in the case of polyurethane, the number of repeating unit is one or more, which includes various forms with a urethane bond formed by polymerization of diisocyanate and diamine, and means a form in which two or more polyurethanes in which structures of main chains thereof are different from each other are randomly bound to each other at the time of forming a random copolymer.

In the present invention, it is preferable that the random copolymer commonly includes repeating units induced from monomers configuring the block copolymer as the repeating unit included in the random copolymer. For example, in the case of using the polymethylmethacrylate-block-polystyrene as the block copolymer, a preferable random copolymer may include a repeating unit induced from a styrene based monomer and a repeating unit induced from a methacrylate based monomer, and in the case of using the polyvinylpyridine-block-polymethylmethacrylate, a preferable random copolymer may include a repeating unit induced from a vinyl pyridine based monomer and a repeating unit induced from a methacrylate based monomer.

In the present invention, a polymerization ratio of these monomers is not limited. However, the block copolymer includes 1 to 99 wt % of the styrene based monomer and 99 to 1 wt % of the methacrylate based monomer, more preferably, 10 to 90 wt % of the styrene based monomer and 90 to 10 wt % of the methacrylate based monomer, which is preferable in that a defect removal efficiency of the block copolymer is particularly high.

In the present invention, it is preferable that the random copolymer has an average molecular weight smaller than that of the block copolymer. As a specific example, the random copolymer may have a number average molecular weight of 1,000 to 3,000,000 g/mol. When the number average molecular weight is smaller than 1,000 g/mol, the random copolymer does not have sufficient chemical preference, such that it may be difficult to use the random copolymer as the reducing agent of Flory-Huggins interaction parameter (χ), and when the number average molecular weight is larger than 3,000,000 g/mol, the random copolymer is not sufficiently mixed in the block copolymer thin film, but may rather act as a defect.

As a specific example of the reducing agent of Flory-Huggins interaction parameter (χ), the block oligomer may means an oligomer in which one or two or more monomers are polymerized in a block form on a small scale, and a degree of polymerization is not limited, but it is preferable that 2 to 20 monomers or oligomers are polymerized. Further, the kind of monomer or oligomer is not limited, and a monomer or oligomer equal to or different from that in the block copolymer or random copolymer may also be polymerized.

In the present invention, an oligomer capable of being used to prepare the block oligomer may be, for example, any one or two or more selected from a urethane based oligomer, an epoxy based oligomer, an arylene based oligomer, an amide based oligomer, an ester based oligomer, a carbonate based oligomer, an imide based oligomer, a sulfone based oligomer, a siloxane based oligomer, a silazane based oligomer, an ether based oligomer, a urea based oligomer, a vinyl based addition oligomer, and an acrylate based oligomer.

As a specific example of the reducing agent of Flory-Huggins interaction parameter (χ), the surface-treated inorganic particles may be particles which have an average particle size of several nano meters and of which surfaces are coated with a random copolymer, a block oligomer, a block copolymer, or the like. The surface-treated inorganic particles may eat into a defect in a thin film to reduce a χN value in the vicinity of the defect, equally to the random copolymer or the block oligomer.

In the present invention, the kind of material coated on the surfaces of the inorganic particles is not limited, and the above-mentioned random copolymer or block oligomer, etc., may also be coated. Further, a coating thickness, a treatment method, and the like, are not limited.

In the present invention, the inorganic particles are not particularly limited as long as they are core particles capable of being coated, and both conductive and non-conductive inorganic particles may be used. In addition, although a particle size is not limited, as the particle size of the inorganic particles is decreased, an influence of the inorganic particles on a shape of the pattern may be decreased, penetration may be improved, and a fine pattern may be formed. Therefore, the inorganic particles may have a particle size of preferably 20 nm or less, and more preferably, 0.1 to 10 nm.

As a specific example of the reducing agent of Flory-Huggins interaction parameter (χ), the solvent is to reduce the χN value of the block copolymer, and the kind of solvent is not limited. That is, an inorganic or organic solvent may be used. However, since at the time of thermal treatment for self-assembly of the block copolymer, if evaporation easily occurs, defect melting does not suitably occur, it is preferable to use a solvent having a boil point of 170° C. or more, preferably 170 to 220° C.

Examples of the solvent may include ether based solvents such as ethylene glycol monobutyl ether acetate, diethylene glycol monobutyl ether acetate, diethylene glycol monoethyl ether acetate, diethylene glycol monomethyl ether acetate, dipropylene glycol monomethyl ether acetate, dipropylene glycol monoethyl ether acetate, dipropylene glycol propyl ether acetate, dipropylene glycol monobutyl ether acetate, diethylene glycol monomethyl ether, diethylene glycol monoethyl ether, diethylene glycol monopropyl ether, diethylene glycol monobutyl ether, diethylene glycol monohexyl ether, triethylene glycol monomethyl ether, triethylene glycol monoethyl ether, triethylene glycol monobutyl ether, triethylene glycol monopropyl ether, dipropylene glycol monobutyl ether, tripropylene glycol monomethyl ether, and tripropylene glycol monobutyl ether; one or more lactone based solvents selected from gamma-valerolactone, delta-valerolactone, gamma-butyrolactone, gamma-hexalactone, gamma-octalactone, gamma-decanolactone, delta-octanolactone, and delta-dodecanolactone; one or more aromatic solvents selected from cyclohexylbenzene, dodecylbenzene, 1,2,3,4-tetramethylbenzene, o-dihydroxybenzene; one or more sulfone based solvents selected from dimethyl sulfoxide, sulfolane, dimethylsulfolane, and dibutylsulfone; and the like. In addition, examples of the solvent may further include dimethyl formamide, N-methyl-2-pyrrolidone, N-ethyl-2-pyrrolidone, diisononyl-1,2-cyclohexane-dicarboxylate, 1,3-dimethylpropyleneurea tri-n-octylphosphine oxide, hexamethylphosphoramide, 3-methyl-2-oxazolidone, 2-oxazolidone, catechol, N,N-dibutylurea, and the like, but the present invention is not limited thereto.

Meanwhile, in the method for increasing the temperature of the self-assembling material applied onto the substrate, the increasing of the temperature may further include performing thermal annealing. That is, the temperature may be increased by light irradiation, and additionally, the temperature may be increased by additionally performing the thermal annealing. The thermal annealing may be selectively performed as needed, and in the case in which the temperature of the self-assembling material is sufficiently increased by light irradiation, thermal annealing may not be performed.

A thermal annealing method is a method for applying heat at a temperature equal to or higher than a glass transition temperature of a polymer in the self-assembling material to align the self-assembling material, and it is preferable to differently adjust an annealing temperature and an annealing time depending on to what extent the temperature of the self-assembling material is increased by light irradiation. As a specific example, the annealing may be performed at 150 to 300° C. for 1 minute to 10 hours, but is not limited thereto.

Hereinafter, as more specific examples, first and second aspects of the method for manufacturing a nano-pattern according to the present invention will be described.

First, the method for manufacturing a nano-pattern according to the first aspect of the present invention will be described.

In an existing method for forming a self-assembly pattern, which is to form a pattern by increasing a temperature as described above, heat cannot but to be isotropically applied to an entire substrate, and it is significantly difficult to instantly apply a high temperature to a local portion of the substrate to induce self-assembly only in the corresponding portion.

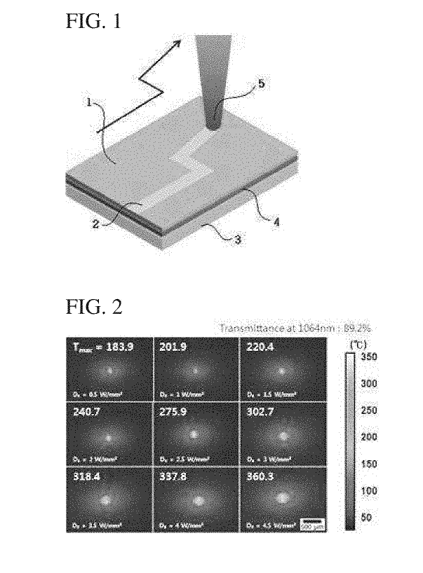

The present invention is to solve this problem. According to the present invention, self-assembly may be selectively induced only in an irradiated portion by light irradiation as illustrated in FIG. 1, and since there is no need to apply a high temperature, it is possible to suppress unnecessary self-assembly capable of occurring in a portion that is not irradiated with light. Further, a specific environment is not required, and a process may be performed even at room temperature under a general air atmosphere. Here, a significantly stable and uniform pattern may be formed in accordance with monomers configuring the block copolymer by adjusting conditions such as a wavelength of light, a size of a region irradiated with light, an energy density, a light scan velocity, and the like.

Further, only the portion irradiated with light may be selectively self-assembled regardless of a shape of the substrate. For example, even though the portion irradiated with light is a curved portion, an edge portion, an irregular portion, or the like, there is no problem in applying this method, and a pattern may be stably formed regardless of a material of the substrate such as a glass substrate, a polyimide substrate, a flexible substrate, or the like.

More specifically, in the method for manufacturing a nano-pattern according to the first aspect of the present invention, directed self-assembly is induced after a complete disordered state is made by inducing χN (here, χ is a Flory-Huggins interaction parameter, and N is a degree of polymerization of a polymer in the self-assembling material) of the self-assembling material to be 10.5 or less in a region irradiated with light.

In the first aspect of the present invention, the desired χN value may be achieved only by the self-assembling material, but in the case in which a χN value is high, the χN value may be allowed to be 10.5 or less by using the reducing agent of Flory-Huggins interaction parameter (χ) as described above.

More specifically, coupled with an increase in a temperature of a pattern portion of the polymer layer in the case of irradiating light to a polymer layer, the χN value in the region irradiated with light may be lowered to 10.5 or less, such that the corresponding region may be made in the disordered state, and the pattern of the block copolymer may be rearranged.

In more detail, χ is a numerical value decreasing depending on a temperature, (χ∝1/T), and when a temperature of a thin film is continuously increased by light irradiation to arrive at an order-disorder phase transition temperature (T_{ODT}), the χN value is also reduced to be close to 10.5. However, depending on the block copolymer, no matter how high the temperature is raised, a case in which the χN value is not reduced to be 10.5 or less may occur. In this case, the χN value of the corresponding portion may be reduced to 10.5 or less and the polymer pattern may be rearranged by adding the reducing agent of Flory-Huggins interaction parameter (χ).

As described above, since the χN value is a value capable of being changed depending on the kind and a molecular weight of polymer, the kind of solvent, a temperature, a crosslinking structure, and the like, the reducing agent of Flory-Huggins interaction parameter (χ) needs to be added in consideration of these variables so as to be less than 10.5. As an example, when the block copolymer is a copolymer of polymethylmethacrylate and polystyrene which have molecular weights of 25 kg/mol and 26 kg/mol, respectively, a mole fraction of the reducing agent of Flory-Huggins interaction parameter (χ) is represented by Φrandom, and a mole fraction of the block copolymer is represented by 1-Φrandom, in the case in which χNBP=18 and Φrandom=0.4, a χN value of a defect is 10.5 or less, which is the same value of an order-disorder transition state, and in the case in which the χN value is reduced below 10.5, a χN value of an entire thin film is reduced, alignment of a fine nano-pattern does not occur any more, and a disordered state is formed overall.

In the case of reducing the χN value of the portion irradiated with light to be 10.5 or less as described above, an energy barrier required to form a pattern may be significantly lowered, and at the same time, the pattern may be quickly and uniformly rearranged, thereby making it possible to more effectively manufacture the pattern in a desired shape.

In the first aspect of the present invention, a content of the reducing agent of Flory-Huggins interaction parameter (χ) may be freely adjusted depending on a molecular weight of the block copolymer or the kind of reducing agent of Flory-Huggins interaction parameter (χ), but it is preferable that the reducing agent of Flory-Huggins interaction parameter (χ) is contained in a content of 1 to 99 wt %, more preferably 10 to 50 wt % based on 100 wt % of an entire mixture. In the case in which the content is less than 1 wt %, a defect melting effect is not suitably exhibited, and in the case in which the content is more than 99 wt %, an entire χN value of a block copolymer composition forming the thin film is reduced below 10.5, such that a pattern is not formed, and entirely, a disordered state is formed.

For example, when blocks configuring the block copolymer are polystyrene-polymethylmethacrylate and have molecular weights of 25 kg/mol and 26 kg/mol, respectively, it is preferable that the content of the reducing agent of Flory-Huggins interaction parameter (χ) is 28 to 32 wt % based on 100 wt % of the entire mixture. However, the content range is only an example in which the block copolymer has the above-mentioned molecular weight, but an optimal composition ratio may be changed within 1 to 99 wt % depending on the molecular weight of the block copolymer, a molecular weight and a size of the reducing agent of Flory-Huggins interaction parameter (χ), and the like, but the present invention is not limited thereto.

Next, after forming the polymer layer by applying the self-assembling material onto the substrate on which the photothermal conversion layer is formed, the directed self-assembly may be induced after the complete disordered state is made by irradiating light to the polymer layer to induce the χN value of the self-assembling material to be 10.5 or less in the region irradiated with light.

In an exemplary embodiment according to the first aspect of the present invention, the light is to supply energy to the photothermal conversion layer or the polymer layer applied on the substrate to induce self-assembly of the polymer layer, and the kind of light, a wavelength, an energy density, a light scan velocity, and the like, are not limited as long as the light does not cause degradation of organic polymeric molecules.

In the first aspect of the present invention, the light may include laser light, and examples of a light source, there are a solid-state laser for high power, a gas laser and a gas laser with a high stable operation, and the like. However, the present invention is not limited thereto, but as long as the light may implement the present invention, the light is not particularly limited.

In the first aspect of the present invention, the light may be irradiated to the self-assembling material by three-dimensional movement of the light source. Therefore, the light may be applied to a substrate having a three-dimensional structure as well as a substrate having a two-dimensional structure. For example, the light may be applied to a flexible substrate, a spherical substrate, a hexahedral substrate, a semiconductor substrate having a complicated three-dimensional structure, or the like. That is, in the case of using a stage including light having a three-dimensional movement direction, molecular self-assembly may be selectively induced in a significantly small portion as if it is painted. Molecular self-assembly may be selectively induced in a desired region as described above, which is significantly important, and this method has high compatibility with other various methods, such that this method may be utilized in various forms.

In the exemplary embodiment according to the first aspect of the present invention, the nano-pattern may be formed by irradiating light while locally moving the light. Since light may be locally irradiated to the substrate by a method for forming a pattern using light, orientation may be selectively adjusted, and a degree of orientation adjustment may also be improved.

In the exemplary embodiment according to the first aspect of the present invention, the wavelength of the light is not limited as long as the light has a wavelength in a region in which there is no selective reaction with the block copolymer contained in the polymer layer. However, it is preferable that the light has a wavelength in a visible region, a near infrared (IR) region, or a far-infrared region so as not to cause thermal degradation in the block copolymer or the reducing agent of Flory-Huggins interaction parameter (χ) contained in the polymer layer. For example, in the case of the block copolymer, when light having a wavelength in an ultraviolet (UV) region is irradiated, a crosslinking reaction between chains occurs, such that it is impossible to induce self-assembly. Therefore, the light having a wavelength in the visible region or near-IR region except for the wavelength in the UV region may be used without any problem.

More specifically, in the first aspect of the present invention, it is preferable that the self-assembling material satisfies the following Correlation Equation 1 while light is irradiated, wherein T_{ODT} means a temperature at which a state of the self-assembling material is changed from an ordered state to a disordered state.

0.8×T_{ODT}≦T₁≦3.0×T_{ODT} [Correlation Equation 1]

(In Correlation Equation 1, T₁ is a temperature (° C.) of the self-assembling material, and T_{ODT} is an order-disorder phase transition temperature (° C.) of the self-assembling material.)

Since the nano structure formed by the self-assembling material containing the block copolymer is a thermodynamically stable structure, the nano structure is spontaneously formed. However, in order to form the nanostructure by the block copolymer, there is a need to apply energy to a polymer to rearrange chains of the block copolymer.

When light energy is applied to the polymer layer, the light energy is converted into heat energy in the photothermal conversion layer, and the heat energy is received in the polymer layer. The chains of the block copolymer are dispersed by heating using the light, and micro phase separation may occur. Further, when the temperature of the polymer layer is further increased, various patterns of a lamellar phase, a cylindrical phase, and the like, may grow depending on the degree of polymerization of the block copolymer. However, there is a problem in that these patterns are not arranged in a constant direction, but are randomly oriented, and thus it is difficult to apply these patterns to a desired nano device.

Therefore, in order to obtain an aligned nano-pattern to be desired, there is a need to adjust a temperature applied to the block copolymer in a specific range. Particularly, when the temperature applied to the polymer is increased, the randomly oriented pattern as described above is changed into a disordered state, and thus, the block copolymer is rearranged. In order to convert the pattern of the block copolymer to the disordered state, it is preferable to increase a temperature of the photothermal conversion layer closely to the order-disorder phase transition temperature (T_{ODT}). That is, in the case of adjusting the energy density, the scan velocity, an irradiation time, and the like, so that the temperature of the photothermal conversion layer is in a range of Correlation Equation 1, while further adding the reducing agent of Flory-Huggins interaction parameter (χ) at the time of forming the polymer layer, the block copolymer is naturally converted into the disordered state, and the temperature is decreased immediately after the light passes, thereby making it possible to obtain a pattern well-aligned in a constant direction.

In the present invention, T₁ in Correlation Equation 1 is limited to a temperature lower than T_{ODT}, but it is preferable that T₁ is higher than T_{ODT} in order to induce the disordered state in the irradiated region.

In order to satisfy Correlation Equation 1, the wavelength of the light according to the present invention may be 380 nm or more, more specifically, 380 to 100,000 nm, and most preferably 500 to 15,000 nm. For example, any light may be used without any problem as long as the light has a wavelength in a region in which there is no selective reaction with self-assembling molecules. For example, in the case of the block copolymer, when light having a wavelength in an ultraviolet (UV) region is irradiated, a crosslinking reaction between chains occurs, such that it is impossible to induce molecular self-assembly. Therefore, the light having a wavelength in the visible region or near-IR region except for the wavelength in the UV region may be used without any problem.

However, in the case of light having a short wavelength below 380 nm, a crosslinking reaction between the block copolymers may occur as described above, such that it may be difficult to form a uniform pattern, and worst of all, degradation may occur. Therefore, it is preferable that the wavelength of the light is within the above-mentioned range.

In the first aspect of the present invention, the energy density of the light is a factor of adjusting a temperature of the irradiated region in the polymer layer to induce self-assembly. Although a temperature may be changed depending on a polymerization density of a polymerization monomer or monomer of the block copolymer contained in the polymer layer, generally, a temperature of 100 to 300° C. may be required. When a temperature is higher than the above-mentioned temperature, degradation of the polymer may occur, and when the temperature is lower than the above-mentioned range, self-assembly itself may not occur. Therefore, it is important to adjust the energy density of the light.

In the first aspect of the present invention, the energy density of the light may be 0.001 to 200,000 W/mm², more preferably, 0.01 to 500 W/mm², and most preferably 1 to 50 W/mm². Molecular self-assembly may be induced by adjusting the energy density within the above-mentioned range to adjust a temperature of a focused region. In the self-assembling molecule, generally, a temperature of 100 to 300° C. or so (which is not relatively high) is required. Therefore, molecular self-assembly may be efficiently induced by suitably adjusting the energy density in accordance with conditions such as the kind of substrate, the wavelength of the light, a size of the focused region, or the like.

In the first aspect of the present invention, when the energy density is less than 0.001 W/mm², self-assembly of the polymer layer is not performed, and when the energy density is more than 200,000 W/mm², the block copolymer may be crosslinked or degraded. However, the energy density may be freely changed depending on the polymerization monomer of the block copolymer for inducing self-assembly, the molecular weight, whether or not the reducing agent of Flory-Huggins interaction parameter (χ) is added, or the like, and the present invention is not limited thereto.

In the first aspect of the present invention, the light scan velocity is a factor determining a degree of formation of self-assembly of the irradiated polymer layer regardless of a progressing direction, and in the case in which the light scan velocity is increased, a thermal gradient and temperature of the focused region may be decreased. Further, as the energy density is increased, the scan velocity may further exceed the above-mentioned range. Therefore, molecular self-assembly may be efficiently induced in the substrate by suitably calculating the light scan velocity and adjusting the light scan velocity depending on the conditions described above. However, the present invention is not limited by the scan velocity range, but the scan velocity may be adjusted to exceed the range described below depending on the kind of substrate, the wavelength of the light, the size of the focused region, the energy density, or the like.

In the first aspect of the present invention, the light scan velocity may be 0.001 nm/s to 100 cm/s, preferably, 0.1 nm/s to 10 cm/s, and most preferably 10 nm/s to 1 cm/s. The scan velocity is irrelevant to a scan direction, and generally, in the case in which a light scan velocity is increased under the same conditions, a thermal gradient and temperature of a focused region may be decreased. Further, as the energy density is increased, the scan velocity may further exceed the above-mentioned range. Therefore, molecular self-assembly may be efficiently induced in the substrate by suitably calculating the scan velocity and adjusting the light scan velocity according to the conditions described above.

In the case in which the light scan velocity is less than 0.001 nm/s, the polymer may burn due to excessive supply of energy, and in the case in which the scan velocity is more than 100 cm/s, self-assembly of the polymer may not suitably occur. However, the light scan velocity may be freely changed depending on the polymerization monomer of the block copolymer for inducing self-assembly, the molecular weight, whether or not the reducing agent of Flory-Huggins interaction parameter (χ) is added, or the like, similarly to the energy density, and the present invention is not limited thereto.

In the first aspect of the present invention, a width of a light spot may be freely adjusted in a desired region depending on a size, a shape, and a manufacturing purpose of the substrate or the polymer layer, and the present invention is not limited thereto.

In more detail, for example, the width of the light spot may be 10 nm or more, specifically, 10 nm to 10 cm, preferably, 50 nm to 1 cm, and more preferably 100 nm to 0.5 cm.

Molecular self-assembly may also be induced in a significantly fine portion as well as a selective portion by adjusting the width of the light spot to which the light is irradiated. For example, if necessary, at the time of inducing molecular self-assembly in a minute region, the light may be applied so that the width of the light spot is narrow. Otherwise, a process time may be decreased by increasing the width of the light spot. Therefore, this technology may induce molecular self-assembly even in a non-planar substrate, and be applied to a substrate having a three-dimensional structure. However, the present invention is not limited by the width range of the light spot, but molecular self-assembly may be induced in a finer region depending on performance of a light irradiation apparatus.

In the exemplary embodiment according to the first aspect of the present invention, the self-assembling material in the region irradiated with light may have a thermal gradient of 20 to 1,200° C./mm with respect to the self-assembling material in a region that is not irradiated with light. Preferably, the thermal gradient may be 100 to 1200° C./mm, and more preferably 200 to 1200° C./mm. As an example, in the present invention, a significantly high thermal gradient of 1100° C./mm or more may be implemented by irradiating light without a separate heating block. In the case of finely adjusting the width of the light spot, a temperature may be increased only in a significantly local region, thereby making it possible to implement a significantly high thermal gradient. Therefore, molecular self-assembly may be selectively induced in a fine region, which means that this method may also be applied to the substrate having a three-dimensional structure. However, the present invention is not limited by the thermal gradient range. Meanwhile, in the present invention, the thermal gradient, which is a primary differential value of a temperature in a specific direction, means a temperature change rate from one point to another point, and is a value obtained by dividing a temperature difference between two points by a distance.

In the exemplary embodiment according to the first aspect of the present invention, a temperature of the substrate positioned below the region irradiated with light may be 50 to 500° C. Since at the time of irradiating light, the temperature of a substrate layer may be controlled by adjusting conditions such as the kind of substrate, the width of the light, the size of the focused region, the energy density, the scan velocity, or the like, molecular self-assembly may be efficiently induced.

Next, the method for manufacturing a nano-pattern according to the second aspect of the present invention will be described.

An existing thermal annealing method or solvent annealing method has a disadvantage in that since a long thermal treatment time is required, a sample needs to be exposed at a high temperature for a long period of time, and a process time is slightly long. Therefore, in this method, there is a problem in that a domain may be broken or the sample may be modified. Further, since an annealing process needs to be performed under vacuum or inert gas atmosphere, process efficiency may be deteriorated.

Therefore, the present inventors studied for a long time in order to provide a method capable of forming a pattern within a significantly short time, and found that in the case of annealing a self-assembling material using a FLA type lamp instantly emitting high energy, a self-assembly pattern may be formed within a very short time, that is, milliseconds (ms) even under the air atmosphere, thereby completing the second aspect of the present invention.

More specifically, in the method for manufacturing a nano-pattern according to the second aspect of the present invention, a self-assembly pattern may be formed by irradiating light using the FLA type lamp.

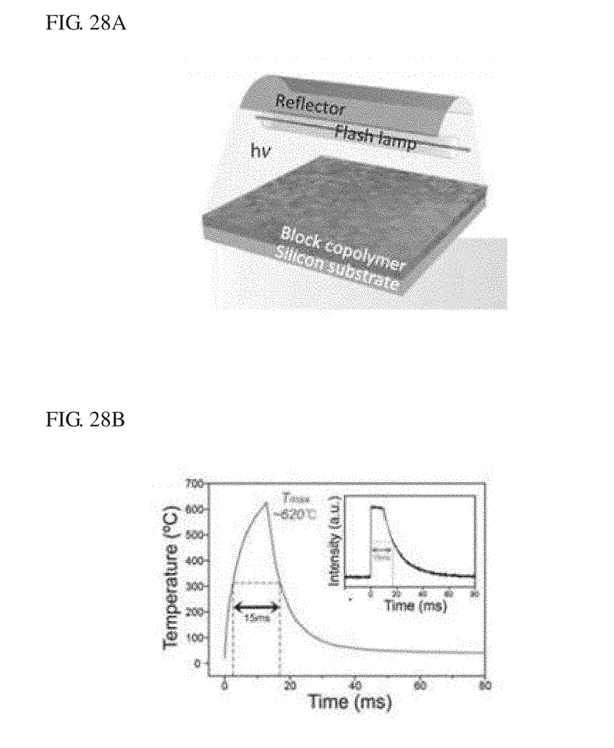

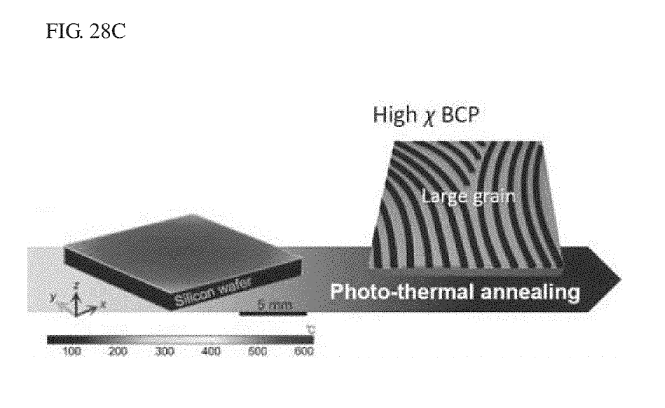

Since the FLA type lamp may instantly irradiate very high intensity light, the lamp may allow a temperature of the self-assembling material including the block copolymer to reach T_{ODT}, a temperature at which self-assembly may occur, within a very short time, thereby making it possible to form a pattern within a very short time, that is, several to several ten milliseconds (ms). In addition, as the annealing time is significantly decreased, the block copolymer is not chemically modified, such that the block copolymer may maintain its unique characteristics, and light is instantly irradiated, as illustrated in FIG. 28C, such that only the polymer layer may be selectively heated. That is, the irradiated light may not affect other layers. Further, there is an advantage in that as the light is irradiated in a pulse form, the annealing time may be adjusted in units of milliseconds by adjusting the number of pulse.

More specifically, the FLA type lamp according to the second aspect of the present invention is not particularly limited as long as it may instantly irradiate high-intensity light, but it is preferable that the FLA type lamp is a xenon flash lamp. The xenon flash lamp may irradiate very-high intensity light within a very short time, that is, several to several ten milliseconds (ms). As a more specific example, a light irradiation intensity of the xenon flash lamp may be 0.1 to 200 J/cm², preferably 1 to 150 J/cm², more preferably, 10 to 100 J/cm², and further more preferably 40 to 100 J/cm². The temperature of the polymer layer may be allowed to instantly reach to T_{ODT} within a short annealing time of several to several ten milliseconds (ms) by using the lamp of high intensity as described above, and thus, the polymer layer may be effectively self-assembled within several to several ten milliseconds (ms). Here, the xenon flash lamp may emit multi-wavelength light including all UV light, visible light and IR light, similarly to sunlight, but if necessary, a wavelength range of the xenon flash lamp may be adjusted. In detail, the xenon flash lamp may be a lamp emitting light in a wavelength range of 300 to 1000 nm, and preferably near infrared (NIR) light in a wavelength of 800 to 950 nm.

As described above, since the xenon flash lamp may instantly irradiate very high-intensity light, the block copolymer may be self-assembled by allowing the self-assembling material containing the block copolymer to instantly reach T_{ODT}. In more detail, for example, the self-assembling material may be heated to 400° C. or more by light irradiation. Here, since an upper limit may be changed by an intensity of light, the upper limit is not particularly limited, but may be, for example, 1500° C. or less. More preferably, the self-assembling material is heated to 600 to 1200° C., which is preferable in that the self-assembling material containing the block copolymer may be effectively self-assembled without damage.

In the second aspect of the present invention, a light irradiation time is not particularly limited, but in view of preventing the block copolymer from being chemically modified, it is preferable that light is irradiated within a short time. More specifically, light irradiation may be performed for a time of 1 second or less. However, in the method for manufacturing a pattern according to the second aspect of the present invention, the pattern may be formed within a very short time, that is, several to several ten milliseconds (ms) as described above, and light irradiation may be performed for preferably 1 to 300 ms, more preferably 10 to 150 ms. Since the self-assembling material containing the block copolymer may be self-assembled within a very short time as described above, a process time may be significantly decreased.

Meanwhile, in the case of using the FLA type lamp, patterns may be formed by self-assembling a wide variety of self-assembling materials. Since, for example, the kind of self-assembling material is the same as described in the general aspect, an overlapping description thereof will be omitted.

Particularly, the block copolymer may be preferably any one or two or more selected from polystyrene-block-polydimethylsiloxane (PS-b-PDMS), polystyrene-block-poly(2-vinylpyridine) (PS-b-P2VP), polystyrene-block-poly(4-vinylpyridine) (PS-b-P4VP), polystyrene-block-polyethyleneoxide (PS-b-PEO), polystyrene-block-polyimide (PS-b-PI), polystyrene-block-polylactic acid (PS-b-PLA), polystyrene-block-polypentafluorostyrene (PS-b-PFS), and the like, and more preferably, the block copolymer may be polystyrene-block-polydimethylsiloxane (PS-b-PDMS). As the block copolymer as described above has χN in a suitable range, a pattern with a large grain may be easily formed by a flash lamp annealing (FLA) method as illustrated in FIGS. 28A to 28C.

In the exemplary embodiment of the present invention, χN (here, χ is a Flory-Huggins interaction parameter, and N is a degree of polymerization of a polymer in the self-assembling material) of the self-assembling material according to the second aspect of the present invention may be in a range of 18 to 50 at 600° C. The self-assembling material satisfies the above-mentioned range, such that at the time of irradiating light using the FLA type lamp, a nano-pattern may be easily formed, and block copolymer molecules may be arranged in the same direction through a wide area, thereby making it possible to form the pattern with a large grain, as compared through Examples to be described below. Here, the block copolymer may be the polystyrene-polydimethylsiloxane block copolymer, and but is not necessarily limited thereto because the χN value may be adjusted by changing a ratio between blocks. However, in the case of using polystyrene-polydimethylsiloxane block copolymer, it may be easy to provide a block copolymer having an χN value of 18 to 50. As described above, χN may be adjusted in a suitable range by adjusting the molecular weight of the block copolymer. As a specific example, the polystyrene-polydimethylsiloxane block copolymer may have a weight average molecular weight of 5,000 to 40,000 g/mol, and more preferably, 10,000 to 30,000 g/mol. Within the above-mentioned range, χN of 18 to 50 may be satisfied.

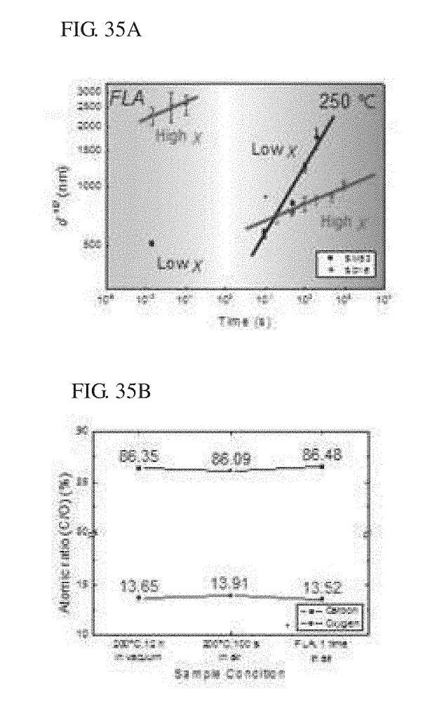

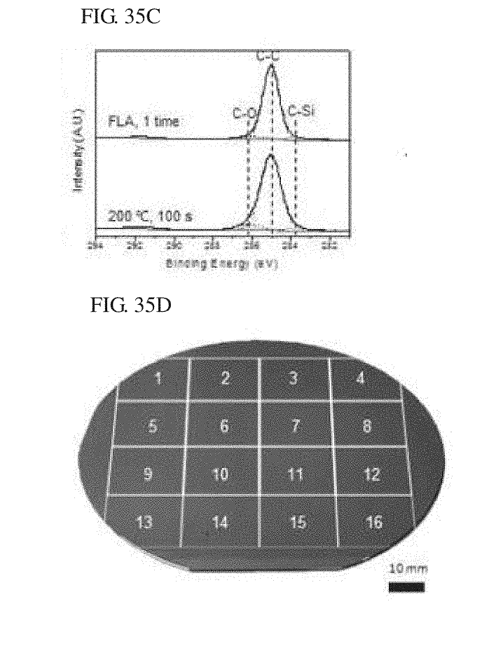

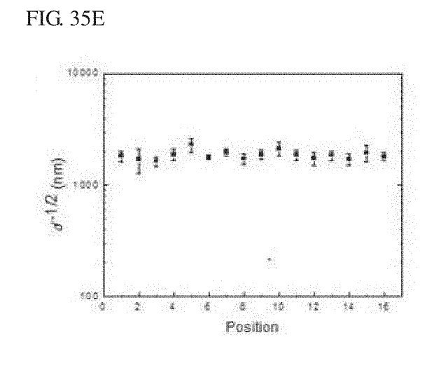

As described above, in a method for forming a pattern according to the present invention, the pattern having a large grain may be formed. An area of the large grain may be confirmed by measuring an average distance between disclinations (that is, inter-disclination distance (d^{-1/2})) in the pattern, and the farther the inter-disclination distance, the larger the area of the grain. More specifically, the self-assembly pattern according to the exemplary embodiment of the present invention may include a large grain having an inter-disclination distance of 1000 nm or more. In this case, the inter-disclination distance may be calculated through the following Calculation Equation 2 after equally dividing a self-assembled block copolymer film into 16 regions (size: 2 cm×2 cm) as illustrated in FIG. 35C, and counting the number of disclinations per unit region. Here, the farther the inter-disclination distance, the larger the area of the grain, and an upper limit of the inter-disclination distance is not particularly limited, but the inter-disclination distance may be, for example, 3000 nm or less.

d^{-1/2}=(N/A)^{-1/2} [Calculation Equation 2]

(In Calculation Equation 2, d^{-1/2} is the inter-disclination distance (nm), N is the number of disclination per unit region, and A is an area of the unit region.)

Meanwhile, a nano-pattern may be formed and a semiconductor device including the nano-pattern may be manufactured using the method for manufacturing a nano-pattern according to the present invention.

A secondary battery, a polarizing plate, a semiconductor device, or the like, may be manufactured using the method for manufacturing a pattern according to the present invention, and examples of the semiconductor device may include a PN junction device, a diode, a bipolar transistor, a field effect transistor, a thyristor, a photoelectric device, and the like. In addition, examples of the semiconductor device may include a device having a laminate structure, a logic device, and the like, and may include various devices such as a complementary metal-oxide semiconductor (CMOS) transistor, display devices, for example, an active matrix organic light-emitting diode (AMOLED) device, a thin film transistor liquid crystal display (TFT-LCD) device, and the like. In addition, examples of the semiconductor device may also include an organic light-emitting diode (OLED), an organic solar cell, an organic photo conductor (OPC), and the like. However, application of the method for manufacturing a nano-pattern according to the present invention is not limited to these semiconductor devices, but the method for manufacturing a nano-pattern may be freely used and applied in various fields in which formation of a pattern is required.

Hereinafter, a large-area pattern according to the present invention, and a method for forming a large-area pattern will be described in more detail through Examples. The following Examples are provided for reference in order to explain the present invention in detail. Therefore, the present invention is not limited thereto but may be implemented in various forms.

Unless otherwise defined, technical terms and scientific terms used in the present specification have the general meaning understood by those skilled in the art to which the present invention pertains. It is to be noted that technical terms used in the present specification are used in order to effectively describe only specific exemplary embodiments rather than restricting the present invention. Unless particularly described, a unit of an additive may be wt %.

### (Measurement of Temperature of Photothermal Conversion Layer)

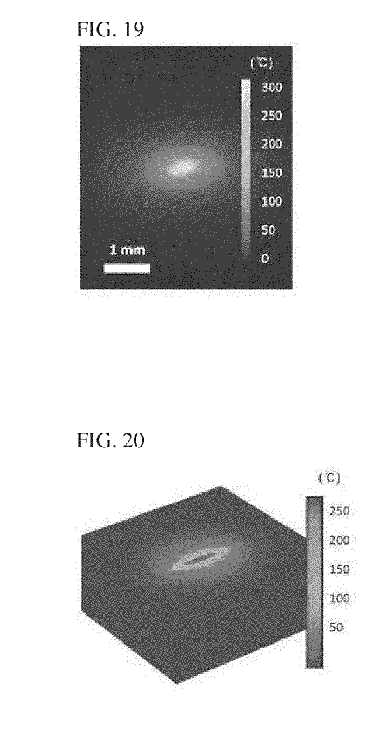

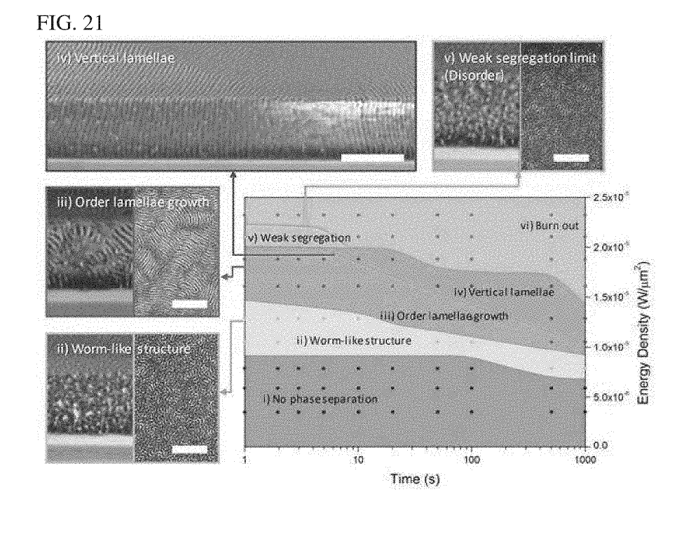

In order to confirm a temperature of a photothermal conversion layer after light irradiation, graphene (chemically modified graphene (CMG), transmittance: 89.2%, thickness: 2 nm) was prepared and deposited on a substrate. Next, neodymium-doped yttrium aluminum garnet laser (wavelength: 1064 nm, pulse operation: 300 kHz, duration time: 200 ns) was irradiated thereon. While laser irradiation was performed, a temperature of graphene was measured using a thermo-graphic camera (T400, manufactured by Flir Systems Inc., U.S) and illustrated in FIGS. 19 and 20.

As illustrated in FIG. 19, it may be appreciated that a temperature of the other portions except for an irradiated portion was room temperature, and a temperature of 250° C. or more was concentrated in a region within a diameter of 250 μm in a central portion of the irradiated portion. Further, it may be appreciated that a temperature of the central portion did not exceed 300° C.

A heat flow at the time of irradiating light in an oval shape according to a finite element method (FEM) confirmed by a computer simulation was illustrated in FIG. 20. In FIG. 20, describing a temperature change of an oval portion (d_{X}: 600 μm, d_{Y}: 100 μm) irradiated with light, it may be appreciated that a temperature was effectively increased up to 280° C. within 400 milliseconds (ms). Particularly, it may be appreciated that a significantly high thermal gradient (ca.1.28 K/μm) that is hardly obtained in a general heating process was recorded through a simple photothermal process.

### Example 1

After reduced graphene oxide was applied as a photothermal conversion layer onto a flat glass substrate, a substrate including the photothermal conversion layer was manufactured by applying a polystyrene-block-polymethylmethacrylate (PS-b-PMMA) block copolymer (polymer source, molecular weight: 51 kg/mol, Canada) at a thickness of 100 nm using a spin coating method.

A laser irradiation stage having a two-dimensional movement direction was installed using a linear stage (XMS100, Newport, Inc.) as an X-axis stage, and another linear stage (PRO165LM, Aerotech Company) as a Y-axis stage. The laser irradiation stage was an apparatus capable of adjusting a velocity from 10 nm/s to 30 cm/s in each axis and performing two-dimensional free movement through X-axis and Y-axis stages.

The substrate was fixed to the stage, and a near infrared (NIR) laser having a wavelength of 1064 nm was irradiated at an energy density of 2 W/mm² and a scan velocity of 100 nm/s after focusing an oval beam (major axis: 300 μm, minor axis:100 μm) using a lens.

### Example 2

The same processes were performed as in Example 1 except that the energy density of the irradiated laser was changed to 0.5, 1, 1.5, 2, 2.5, 3, 3.5, 4, and 4.5 W/mm².

### Example 3

The same processes were performed as in Example 1 except that the thermal gradient was adjusted to 1100° C./mm and the scan velocity at the time of irradiating the laser was changed to 100 nm/s, 250 nm/s, 500 nm/s, 1000 nm/s, and 50 μm/s, respectively.

### Example 4

The same processes were performed as in Example 1 except for using a polyimide substrate (Mitsubishi Gas Chemical, Japan) corresponding to a flexible polymer substrate instead of the flat glass substrate.

### Example 5

The same processes were performed as in Example 1 except for using a substrate having a three-dimensional structure composed of peaks and valleys (micro size) instead of the flat glass substrate.

### Example 6

After reduced graphene oxide was applied as a photothermal conversion layer onto a flat glass substrate, pentacene having a molecular weight of 278.36 g/mol was deposited thereon using an organic molecular-beam deposition method at a deposition velocity of 0.02 nm/s in a vacuum chamber at a temperature of 205° C. The same processes were performed as in Example 1 except for manufacturing a substrate including the photothermal conversion layer by further depositing pentacene at a thickness of 50 nm.

### Example 7

The same processes were performed as in Example 1 except for applying carbon black to a photothermal conversion layer instead of the reduced graphene oxide.

### Example 8

The same processes were performed as in Example 1 except for using polystyrene-block-poly(2-vinylpyridine) (PS-b-P2VP, molecular weight: 38.5 kg/mol) instead of the PS-b-PMMA block copolymer.

### Example 9

The same processes were performed as in Example 1 except for using polystyrene-block-polydimethylsiloxane (PS-b-PDMS, molecular weight: 16 kg/mol) instead of the PS-b-PMMA block copolymer.

### Example 10

The same processes were performed as in Example 1 except for using a mixed poly(3-hexylthiophene/(6,6)-phenyl-C61-butyric acid methyl ester (P3HT/PCBM) thin film instead of the PS-b-PMMA block copolymer and irradiating laser light at an energy density of 22.2 W/mm² for 10 minutes.

### Comparative Example 1

Molecular self-assembly was induced by performing a thermal annealing method according to the related art on a substrate according to Example 1, instead of a laser irradiation method.

### Comparative Example 2

Molecular self-assembly was induced by performing a thermal annealing method according to the related art on a substrate according to Example 4, instead of a laser irradiation method.

### Comparative Example 3

Molecular self-assembly was induced by performing a thermal annealing method according to the related art on a substrate according to Example 5, instead of a laser irradiation method.

FIG. 2 is a graph illustrating a temperature of the substrate at the time of laser irradiation depending on an energy density of the laser according to Example 1. Although the temperature of the substrate is changed depending on conditions such as the kind of substrate, a wavelength of the laser, or a size of a focused region, the temperature of the substrate at the time of laser irradiation may be controlled by adjusting the energy density of the laser. Therefore, molecular self-assembly may be efficiently induced by adjusting a suitable temperature.

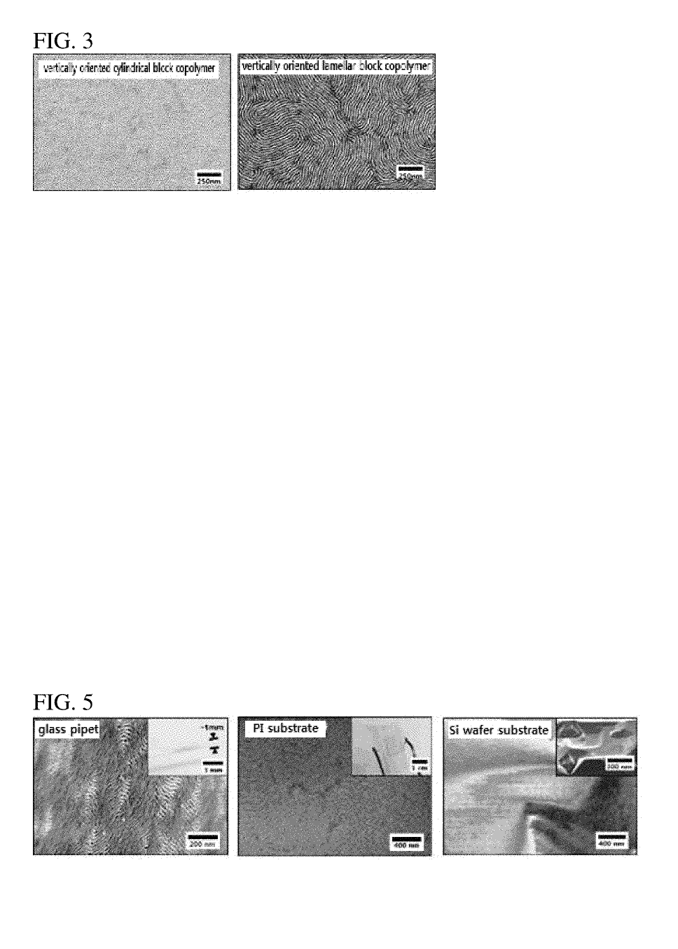

FIG. 3 are scanning electron microscope images obtained by observing substrates according to Examples 1 and 2. It was confirmed that when the energy density of the laser was 2 W/mm², self-assembling molecules were well-aligned in cylindrical and lamellar shapes.

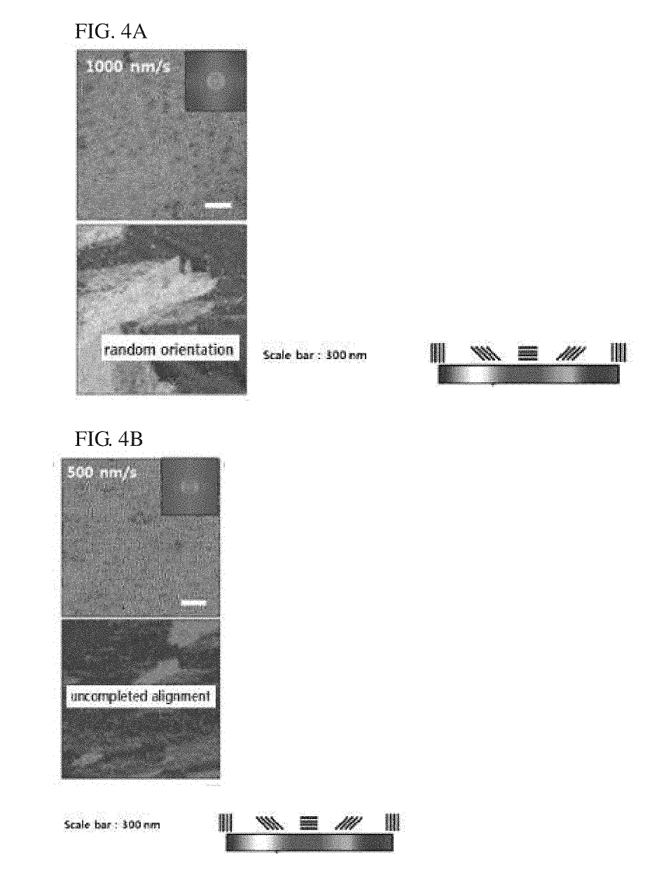

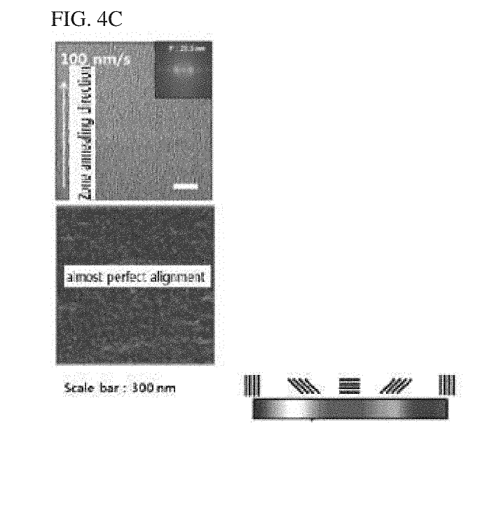

FIGS. 4A, 4B, and 4C are views illustrating degrees of molecular self-assembly alignment of substrates according to Examples 1 and 3 depending on the laser scan velocity. When the scan velocity was less than 250 nm/s, self-assembling molecules were well-aligned on the substrate, and when the scan velocity was 250 to 500 nm/s, self-assembling molecules were aligned to some degrees, but portions in which self-assembling molecules were not aligned were observed.

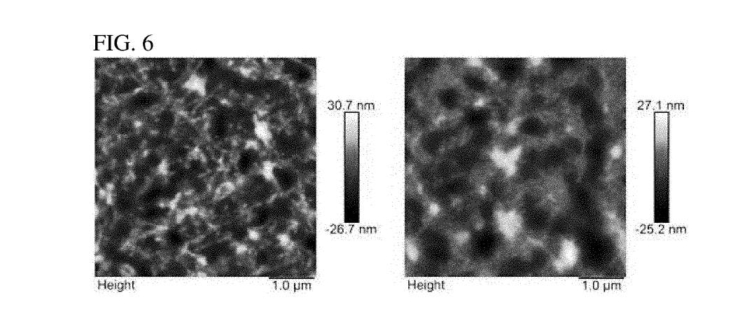

FIG. 5 is scanning electron microscope images obtained by observing substrates according to Examples 1, 4, and 5. Since a method for inducing molecular self-assembly according to the present invention may be used in a non-planar substrate, the method may also be applied to a substrate having a three-dimensional structure or flexible substrate. For example, molecular self-assembly may be induced in a selective region including a fine portion on a glass pipet having a curved surface, the polyimide substrate (Mitsubishi Gas Chemical, Japan) corresponding to a flexible polymer substrate, the substrate having the three-dimensional structure composed of peaks and valleys (micro sizes) by laser irradiation.

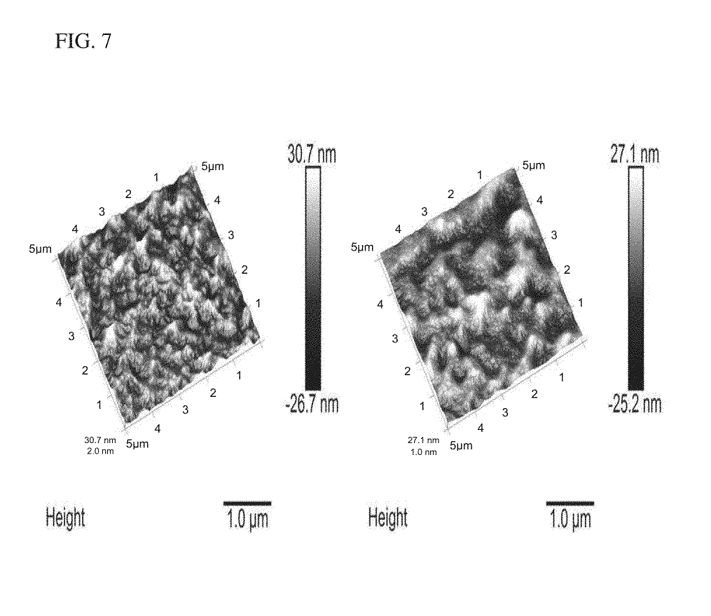

FIGS. 6 and 7 are views obtained by observing the mixed P3HT/PCBM thin film in which molecular self-assembly was induced by laser irradiation according to Example 10 using an atomic force microscope (AFM), wherein FIG. 6 is a two-dimensional image, and FIG. 7 is a three-dimensional image. In FIGS. 6 and 7, left images are images of a mixed P3HT/PCBM thin film substrate before laser irradiation, and right images are images of the mixed P3HT/PCBM thin film in which molecular self-assembly is induced by laser irradiation. As illustrated in the images of the mixed P3HT/PCBM thin film in which molecular self-assembly was induced (the right images in FIGS. 14 and 15), it may be confirmed that although self-assembling molecules were not perfectly aligned as in the cases of the PS-b-PMMA block copolymers in Examples 1 to 5, but partially aligned to some degree (in an experiment for inducing self-assembly in the P3HT thin film in an entire region using a thermal annealing method instead of laser irradiation, partial alignment was reported (JOURNAL OF APPLIED PHYSICS 2005, Vol. 98, 043704, 2005)).

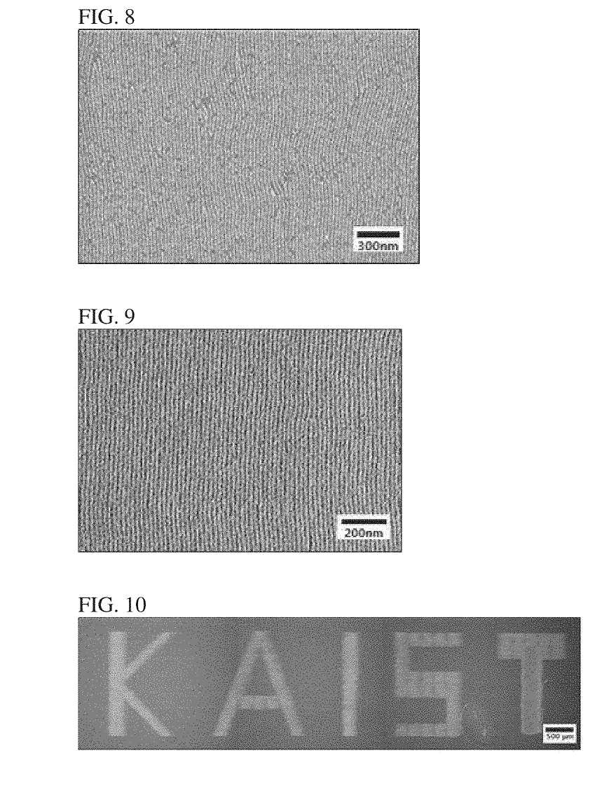

FIG. 8 is a scanning electron microscope image obtained by observing molecular self-assembly alignment of polystyrene-block-poly(2-vinylpyridine) according to Example 8, and FIG. 9 is a scanning electron microscope image obtained by observing molecular self-assembly alignment of polystyrene-block-polydimethylsiloxane according to Example 9. As illustrated in the images, it may be confirmed that the present invention may be applied to various block copolymers as well as the PS-b-PMMA block copolymer.

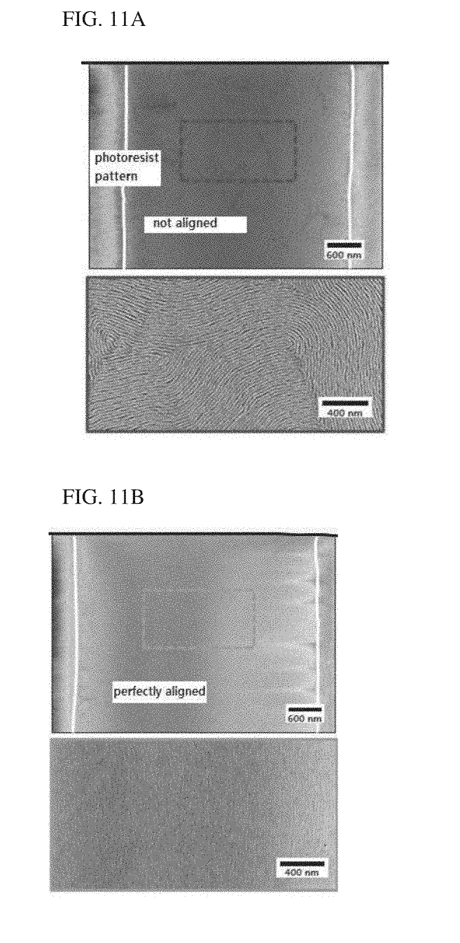

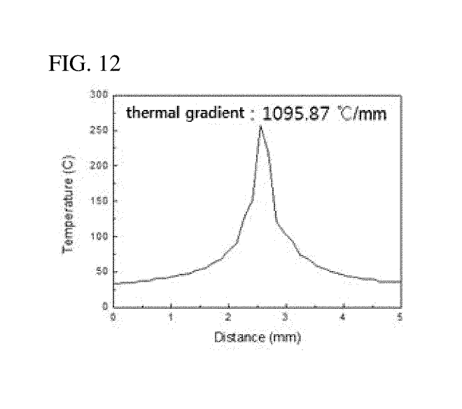

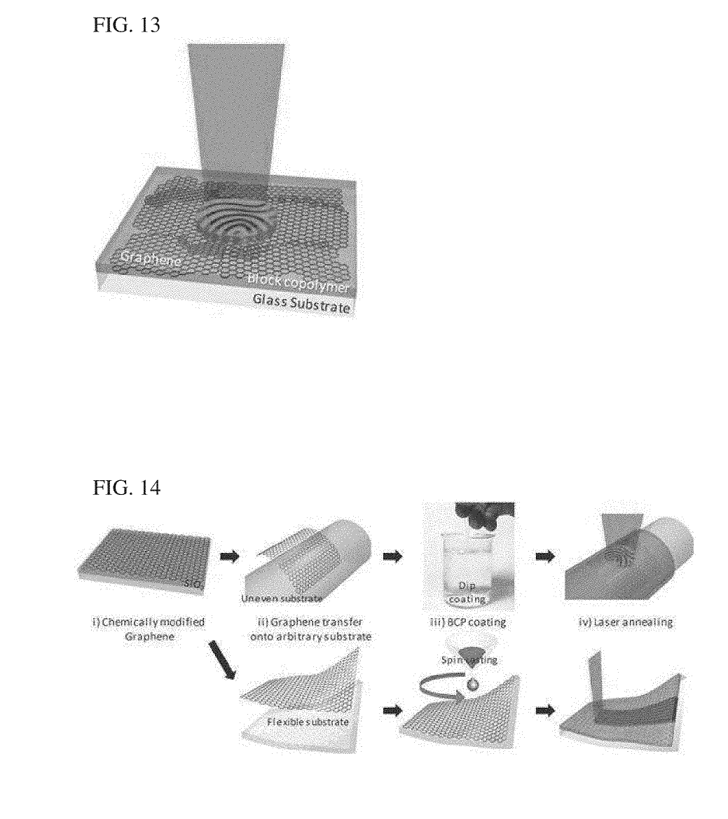

FIG. 10 is a scanning electron microscope image obtained by observing a substrate in which molecular self-assembly is induced in a selective region including a fine portion according to Example 1. As illustrated in FIG. 10, a molecular self-assembly region may be made by combinations with various stages as if it was painted. Along the region irradiated with light including laser, selective self-assembly may be induced by movement of the stage only in the region as if it was handwritten. Applying this result to a three-dimensional stage, it is possible to induce uniform molecular self-assembly by suppressing a portion in which molecular self-assembly was not induced from being partially formed, and it is possible to induce significantly elaborate molecular self-assembly without morphological and structural problems, regardless of the kind of substrate.

FIGS. 11A and 11B are scanning electron microscope images obtained by observing substrates according to Examples 1 and Comparative Example 1. FIG. 11A is an image illustrating a substrate to which general thermal annealing is applied according to Comparative Example 1, and FIG. 11B is an image of a substrate in which molecular self-assembly is induced by laser irradiation according to Example 1. In FIG. 11A, alignment was induced only by a graphoepitaxy method. Therefore, it was observed that self-assembling molecules were not well-aligned in a central portion. However, in FIG. 11B, it may be appreciated that orientation of molecules was adjusted according to the present invention, and thus, a degree of alignment of the self-assembling molecules was significantly improved. It may be appreciated that this method has a significantly high compatibility with an existing method for adjusting orientation of molecules in addition to various methods, and thus, a significantly strong synergic effect may be obtained.

FIG. 20 is a graph illustrating a temperature (° C.) depending on a distance (mm) when molecular self-assembly is induced by irradiating laser focused at a micro size to the substrate according to Example 1, and a significantly high thermal gradient of 1100° C./mm was shown. Self-assembling molecules may be aligned in a selective region including a significantly fine portion through the above-mentioned linear stage using the high thermal gradient. The thermal gradient was measured using a thermo-graphic camera (T400, manufactured by Flir Systems Inc., U.S.).

The following Table 1 illustrates the results according to Examples 1 to 10 and Comparative Examples 1 to 3.

TABLE 1

| | | | Maximum | |
|---|---|---|---|---|
| | Energy | Scan | Thermal | Degree of |
| | Density | Velocity | Gradient | Molecular Self- |
| | (W/mm²) | (nm/s) | (° C./mm) | assembly |
| Example 1 | 2 | 250 | 1096 | very perfect alignment |
| Example 2 | 0.5 | | | perfect alignment |
| | 1 | | | |
| | 1.5 | | | |
| | 2 | | | very perfect alignment |
| | 2.5 | | | perfect alignment |
| | 3 | | | |
| | 3.5 | | | |
| | 4 | | | |
| | 4.5 | | | |
| Example 3 | 2 | 100 | | very perfect alignment |
| | | 250 | | very perfect alignment |
| | | 500 | | partial alignment |
| Example 4 | | 250 | | very perfect alignment |
| Example 5 | | | | |
| Example 6 | | | | |
| Example 7 | | | | |
| Example 8 | | | | |
| Example 9 | | | | |
| Example 10 | 22.2 | | | partial alignment |
| Comparative | 2 | | 17 | Random arrangement |
| Example 1 | | | | |
| Comparative | | | | |
| Example 2 | | | | |
| Comparative | | | | |
| Example 3 | | | | |

As described above, the significantly high thermal gradient may be obtained by irradiating laser beam, and orientation of the self-assembling molecules may be arbitrarily adjusted in the selective region including the significantly fine portion using the high thermal gradient.

In a case of applying self-assembly and orientation adjustment in the selective region as described above to a block copolymer in a lithography technology, or the like, variously aligned pattern may be formed only in a selective region. Further, a block copolymer pattern formed as described above may be applied to a pattern transfer. Therefore, it is expected that the present invention may be applied to a pattern process (pattern size<10 nm), which is a limitation of an existing semiconductor process. In this case, it is expected that various circuit pattern will be implemented by simply dragging light without using a photoresist pattern or chemical pattern in advance.

### Example 11

In order to confirm pattern formation of a polymer layer depending on an irradiation time and an energy density of light, an experiment was performed as follows. First, a laminate of the chemically modified graphene (CMG) and the substrate used in measuring the temperature of the photothermal conversion layer described above was prepared, and a polymer layer was completed by applying a solution in which a polystyrene-block-polymethylmethacrylate block copolymer (number average molecular weight: 25 kg/mol (PS), 26 kg/mol (PMMA)) and polystyrene-random-polymethylmethacrylate copolymer (number average molecular weight: 17 kg/mol) as a reducing agent of Flory-Huggins interaction parameter (χ) were mixed with each other at a ratio of 70 wt %:30 wt % on a surface of CMG. Self-assembly of the polymer layer was induced by irradiating the completed polymer layer with the same laser as the laser irradiated at the time of measuring the temperature of the photothermal conversion layer while changing an irradiation time and an energy density. After irradiation, a shape of a pattern was measured using a scanning electron microscope (SEM), and the result was illustrated in FIG. 21.

As illustrated in FIG. 21, at a low energy density of 10 W/mm² or less, a disordered or worm-like structure was shown regardless of the irradiation time (i and ii regions in FIG. 21). The reason may be that light energy was not enough to form an ordered pattern.

In the case in which the energy density was more than 10 W/mm², the polymer layer started to be aligned in a lamellar shape but was randomly arranged (iii region in FIG. 21), in the case of further increasing the energy density of the laser (irradiation at an energy density of 18.3 W/mm² for 10 seconds), a uniformly oriented pattern was observed throughout the entire irradiated portion (iv region in FIG. 21). Further, it was confirmed that in the case of irradiating laser in an oval shape (dₓ:600 μm, d_{y}:100 μm), a pattern formation portion also had an oval shape (dₓ:300 μm, d_{y}:40 μm).

In the case in which the energy density was more than 21.2 W/mm², a disordered and discontinuous pattern was formed, and generally, alignment/non-alignment transition was observed (v region in FIG. 21). Further, it may be confirmed that in the case in which the energy density was more than 23 W/mm², the polymer layer was degraded and burned out (vi region in FIG. 21).

### Example 12

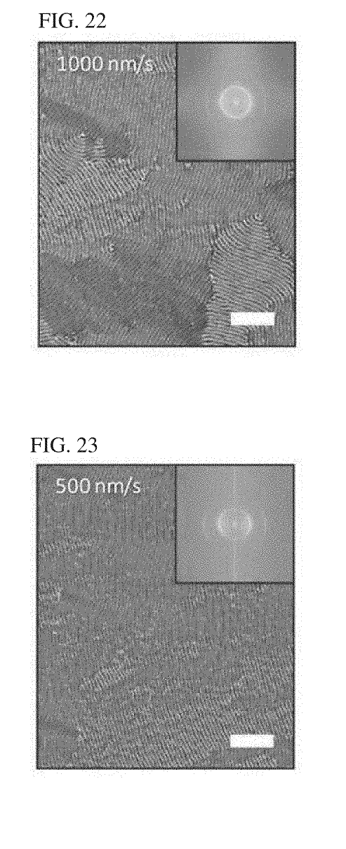

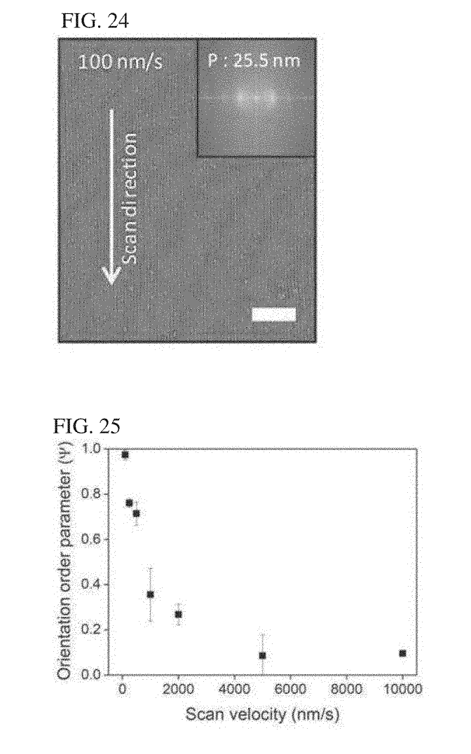

In order to confirm an arrangement state depending on the light scan velocity, an experiment was performed as follows. First, a laminate of the chemically modified graphene (CMG) and the substrate used in Example 11 was prepared, and a polymer layer was completed by applying a solution in which a polystyrene-block-polymethylmethacrylate block copolymer (number average molecular weight: 25 kg/mol (PS), 26 kg/mol (PMMA)) and polystyrene-random-polymethylmethacrylate copolymer (number average molecular weight: 17 kg/mol) as a reducing agent of Flory-Huggins interaction parameter (χ) were mixed with each other at a ratio of 70 wt %:30 wt % on a surface of CMG. The same laser as in Example 11 was irradiated to the completed polymer layer, but the energy density was fixed to 18.3 W/mm² and scan velocities were 1000 nm/s, 500 nm/s, and 250 nm/s, respectively, and the results were illustrated in FIGS. 22 to 24.

As illustrated in FIG. 22, when the scan velocity was 1000 nm/s, a weakly oriented state was observed, and in the case of further decreasing the scan velocity, a further oriented pattern started to be formed at a velocity near 500 nm/s (FIG. 23). It may be confirmed that when the scan velocity was 250 nm/s or less, a pattern which was almost perfectly oriented in the scan direction was formed.

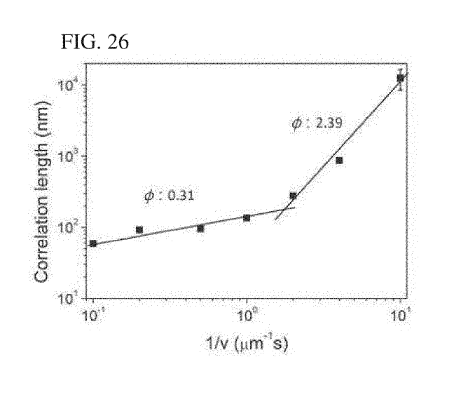

FIGS. 25 and 26 are to describe this result in more detail. First, FIG. 25 illustrates an orientation order parameter (Ψ, the orientation order parameter is close to 1, which means that the block copolymers are aligned in one direction) of the block copolymer in one direction depending on the scan velocity. It may be appreciated that as the laser scan velocity was increased, the orientation order parameter was rapidly decreased, and as the scan velocity was decreased to be 2,000 nm/s or less, the orientation order parameter was rapidly increased.

FIG. 26 illustrates a correlation length depending on a reciprocal (1/v) of the scan velocity. It may be appreciated that a degree of increase in the correlation length was different depending on the mole fraction (Φ) of the block copolymer, but the correlation length was substantially increased in inverse proportion to the scan velocity.

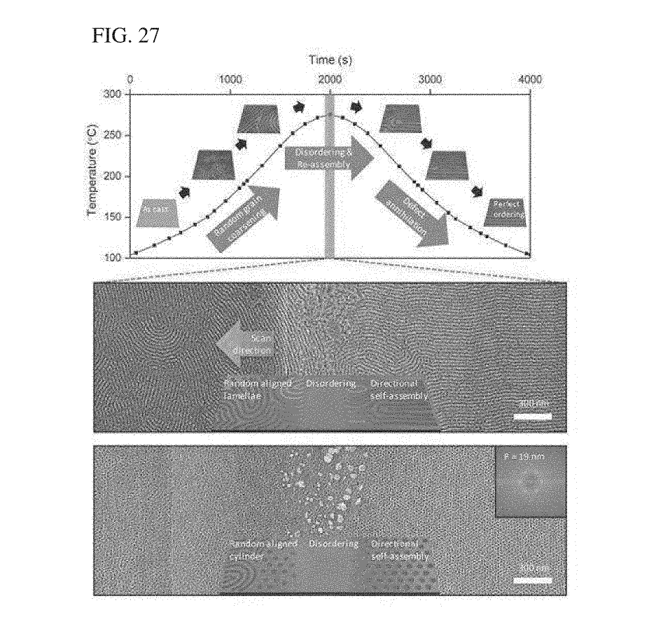

A spontaneous pattern formation process deduced from data in measurement of the temperature of the photothermal conversion layer and in Examples 11 and 12 was illustrated in FIG. 27. As illustrated in an upper portion of FIG. 27, thermal energy is continuously applied to the polymer layer in accordance with increases in temperature and irradiation time, and this thermal energy promotes dispersion and micro phase separation behaviors of chains of the block copolymer. Further, a randomly oriented lamellar domain grows, and a vertical lamellar phase is aligned. Particularly, it may be appreciated that in order to induce a disordered state and rearrangement of the block copolymer configuring the polymer layer, the temperature of the photothermal conversion layer supplying heat to the polymer layer needs to be maintained to be equal to or higher than T_{ODT}.

In more detail, although a target temperature of the photothermal conversion layer was changed depending on a polymerization monomer of the block copolymer configuring the polymer layer, in the Examples in which 30 wt % of the reducing agent of Flory-Huggins interaction parameter (χ) was mixed, χN of a portion irradiated with laser was lowered to 10.5 or less at 280° C., such that occurrence of order-disorder transition was observed. Further, it was confirmed that when the laser passed through the irradiated portion, a temperature of the irradiated portion was slowly decreased to be T_{ODT} or less, and the oriented pattern was naturally aligned and fixed. On the contrary, it may be confirmed that in the case in which a temperature of T_{ODT} or more was not sufficiently applied, a weak alignment effect was observed.

A middle portion of FIG. 27 illustrates results obtained by observing disordering and rearrangement of the block copolymer at a laser scan velocity of 100 nm/s using a SEM. Here, the laser progressed from right to left. Referring to FIG. 27, it may be appreciated that as the laser scan was performed, a temperature of a lamellar phase that was not subjected to laser irradiation to thereby be randomly arranged was increased in accordance with laser irradiation, and the lamellar phase was changed into a disordered state, and as the temperature was decreased again, defects of the block copolymer slowly disappeared, and a well-arranged self-assembly pattern was formed.

A lower portion of FIG. 27 illustrates results obtained by observing an arrangement process of a cylindrical phase (PS-b-PMMA, number average molecular weight: 21.5 kg/mol (PS), 10 kg/mol (PMMA)) using SEM. It may be appreciated that similar to the lamellar phase, as laser scan was performed, a randomly arranged cylindrical phase was observed, and then changed into a disordered state, and as the temperature was decreased again, nanocylinders in which the cylindrical phase was aligned in a hexagonal shape were formed.

### Example 13

A reduced graphene oxide corresponding to chemically modified graphene (CMG) was laminated as a photothermal conversion layer on a polyimide (PI) substrate (thickness: 50 μm).

Next, a polystyrene-polydimethylsiloxane block copolymer (PS-b-PDMS, 11 kg/mol-b-5 kg/mol, SD16) was spin-coated on the substrate at a thickness of 70 nm.

Then, light irradiation (1 pulse, 15 ms, 199V) was performed once thereon under the air atmosphere at a light irradiation intensity of 78.8 J/cm² using a xenon flash lamp, such that the block copolymer was self-assembled due to a photothermal effect to form a lamellar pattern.

### Example 14

All processes were performed in the same manner as in Example 13 except for using PS-b-PDMS (17 kg/mol-b-8 kg/mol, SD25) instead of PS-b-PDMS (11 kg/mol-b-5 kg/mol, SD16).

### Example 15

All processes were performed in the same manner as in Example 13 except for using polystyrene-polymethylmethacrylate block copolymer (PS-b-PMMA, 37 kg/mol-b-16 kg/mol, SM53) instead of PS-b-PDMS (11 kg/mol-b-5 kg/mol, SD16).

### Example 16

All processes were performed in the same manner as in Example 13 except for using PS-b-PDMS (31 kg/mol-b-14 kg/mol, SD45) instead of PS-b-PDMS (11 kg/mol-b-5 kg/mol, SD16).

### Comparative Example 4

A substrate on which PS-b-PDMS was applied was prepared by the same method as in Example 13.

Next, thermal annealing was performed thereon at 250° C. for 1 second under a nitrogen atmosphere, but a pattern was not formed.

### Comparative Example 5

A substrate on which PS-b-PDMS was applied was prepared by the same method as in Example 13.

Next, thermal annealing was performed thereon at 250° C. for 500 seconds under a nitrogen atmosphere, such that a lamellar pattern was formed.

### Comparative Example 6

A substrate on which PS-b-PDMS was applied was prepared by the same method as in Example 14.

Next, thermal annealing was performed thereon at 250° C. for 500 seconds under a nitrogen atmosphere, such that a lamellar pattern was formed.

### Comparative Example 7

A substrate on which PS-b-PMMA was applied was prepared by the same method as in Example 15.

Next, thermal annealing was performed thereon at 250° C. for 500 seconds under a nitrogen atmosphere, such that a lamellar pattern was formed.

TABLE 2

| | Annealing | χN (at | Pattern | | Chemical |
|---|---|---|---|---|---|
| | Time | 600° C.) | Formation | d^{-1/2} | Modification |
| Example 13 | 15 ms | 19.6 | ∘ | 2267 | x |
| Example 14 | 15 ms | 31.3 | ∘ | 700 | x |
| Example 15 | 15 ms | 16.6 | ∘ | 515 | x |
| Example 16 | 15 ms | 54.9 | x | — | x |
| Comparative | 1 s | 19.6 | x | — | x |
| Example 4 | | | | | |
| Comparative | 500 s | 19.6 | ∘ | 867 | ∘ |
| Example 5 | | | | | |
| Comparative | 500 s | 31.3 | ∘ | 200 | ∘ |
| Example 6 | | | | | |
| Comparative | 500 s | 16.6 | ∘ | 2000 | ∘ |
| Example 7 | | | | | |

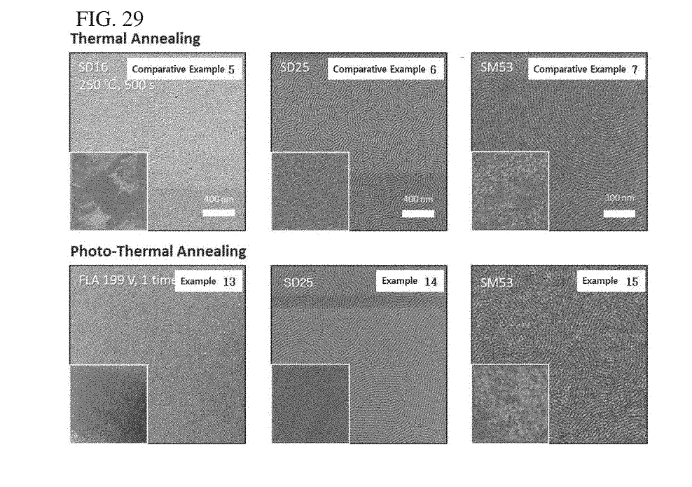

As illustrated in Table 2 and FIG. 29, it may be confirmed that in Examples 13 to 15 in which the block copolymer was self-assembled by instantly irradiating an intensive light using the xenon lamp according to the present invention, the self-assembly pattern was effectively formed.

Particularly, in Example 13 in which χN was in a range of 18 to 50, in spite of a significantly short annealing time of 15 ms, the self-assembly pattern was formed, and block copolymer molecules are oriented in the same direction throughout a wide area, such that an inter-disclination distance was significantly increased due to a significant decrease in disclinations, thereby making it possible to form a pattern having a large grain.

In addition, as illustrated in FIG. 29, it may be confirmed that even though the same block copolymer was used in Example 14, an area of each grain was wider than that in Comparative Example 6 in which the pattern was formed by thermal annealing. Therefore, it may be confirmed that a high-quality self-assembly pattern in which disclinations were decreased may be formed.

It may be confirmed that in Example 15, χN of the block copolymer was less than 18, such that an area of each grain was decreased as compared to Comparative Example 7. Therefore, it may be confirmed that in the self-assembly process using the flash lamp annealing (FLA) method, it is important to use a block copolymer of which χN was within a suitable range.

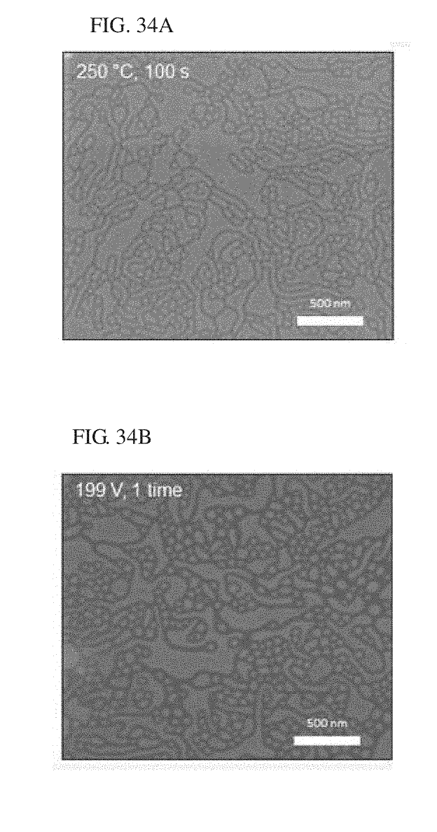

In Example 16, as the block copolymer of which χN at 600° C. was more than 50 was used, a self-assembly pattern was not effectively formed as illustrated in FIGS. 34A and 34B. In addition, even in the case of performing thermal annealing at 250° C. for 100 seconds, the self-assembly pattern was also not formed.

Meanwhile, in Comparative Example 4, even though thermal annealing was performed for 1 second which is 1000 times a millisecond (ms), a pattern was not formed.

It may be confirmed that in Comparative Examples 5 to 7, as annealing was performed for 500 seconds, a pattern was formed, but an area of the grain was narrower than those in Examples, and as the annealing was performed at a high temperature for a long time, the block copolymer was chemically modified.

### Example 17

All processes were performed in the same manner as in Example 13 except for using a silicon (Si) substrate provided with a groove (width: 800 nm, depth: 40 nm) instead of the PI substrate.

### Example 18

All processes were performed in the same manner as in Example 13 except for using a silicon (Si) substrate provided with a cylindrical groove (diameter: 800 nm, depth: 40 nm) instead of the PI substrate.

### Example 19

All processes were performed in the same manner as in Example 13 except for using a silicon (Si) substrate provided with a groove (width: 800 nm, depth: 40 nm) instead of the PI substrate and using PS-b-PDMS (21 kg/mol-b-3.8 kg/mol, SD24.8) instead of PS-b-PDMS (11 kg/mol-b-5 kg/mol, SD16), thereby forming a spherical pattern.

### Comparative Example 8

All processes were performed in the same manner as in Example 13 except for performing thermal annealing at 250° C. for 5 minutes under a nitrogen atmosphere instead of light irradiation.

TABLE 3

| | Annealing | | Pattern | Chemical |
|---|---|---|---|---|
| | Time | χN (at 600° C.) | Formation | Modification |
| Example 17 | 15 ms | 19.6 | ∘ | x |
| Example 18 | 15 ms | 19.6 | ∘ | x |
| Example 19 | 15 ms | 28.8 | ∘ | x |
| Comparative | 300 s | 19.6 | ∘ | ∘ |
| Example 8 | | | | |

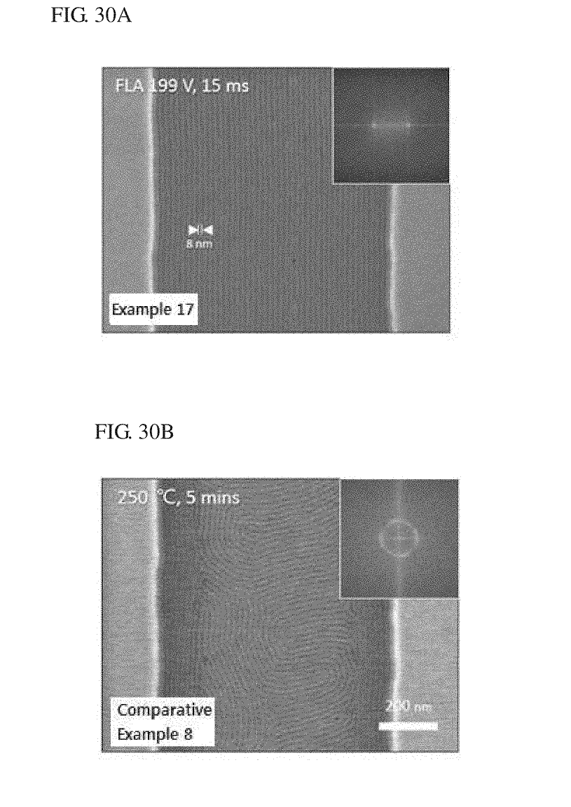

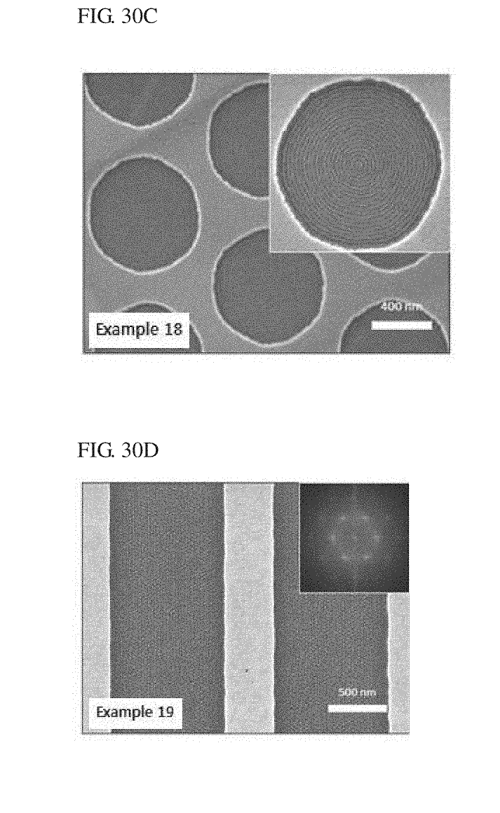

In Examples 17 to 19 and Comparative Example 8, the block copolymer was self-assembled by a graphoepitaxy method. As illustrated in FIGS. 30A, 30B, 30C and 30D, it may be confirmed that in Examples 17 to 19, the block copolymer was effectively self-assembled with predetermined directionality so as to be suitable for a shape of the substrate, but in Comparative Example 8, a pattern was irregularly formed.

### Example 20

All processes were performed in the same manner as in Example 13 except that light irradiation was performed 1 time, 4 times, and 8 times, respectively.

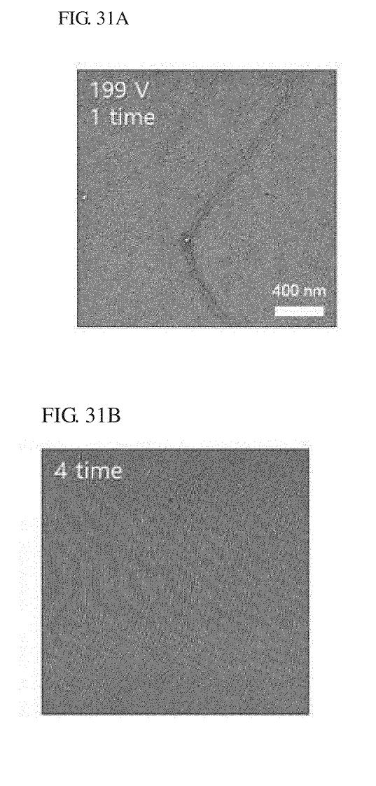

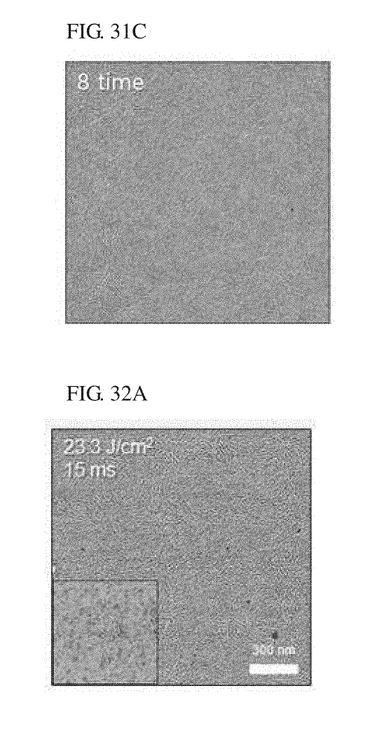

As illustrated in FIGS. 31A, 31B, and 31C, it may be confirmed that the self-assembly pattern was formed only by one-time light irradiation, but as the number of light irradiation was increased, an area of a grain was further increased.

### Example 21

All processes were performed in the same manner as in Example 13 except for changing the light irradiation intensity to 23.3 J/cm², 34.4 J/cm², 45.5 J/cm², 56.6 J/cm², 67.7 J/cm², and 78.8 J/cm², respectively.

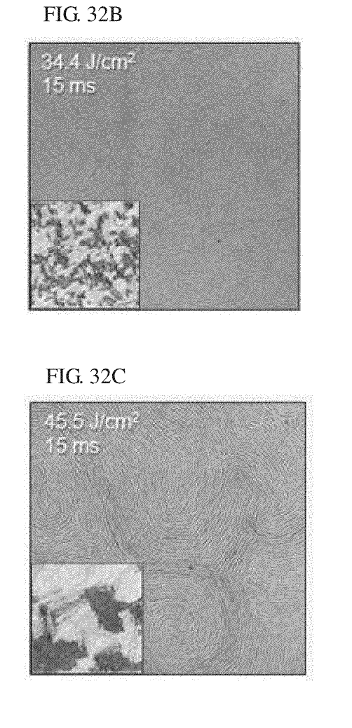

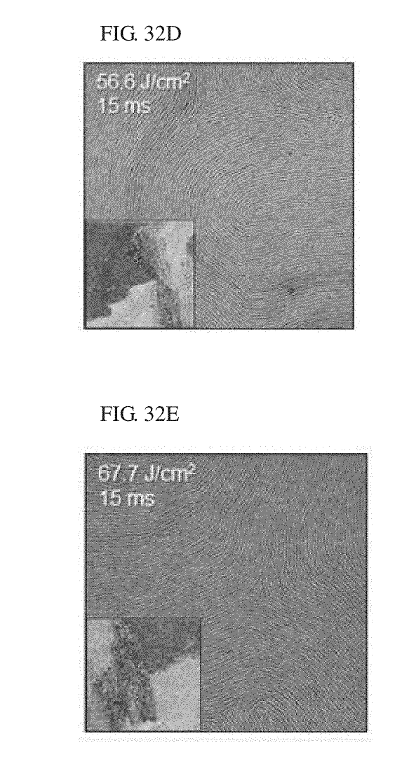

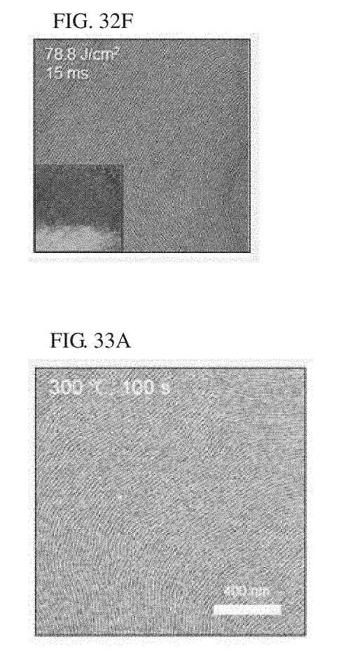

As illustrated in FIGS. 32A, 32B, 32C, 32D, 32D, 32E, and 32F, it may be confirmed that as the light irradiation intensity was increased, the block copolymer was more effectively self-assembled to form a pattern having a large grain.

### Comparative Example 9

The same block copolymer as in Example 13 was used, and all processes were performed in the same manner as in Example 13 except for performing thermal annealing for 100 seconds under a nitrogen atmosphere instead of light irradiation, while changing a temperature to 300° C., 400° C., and 500° C.

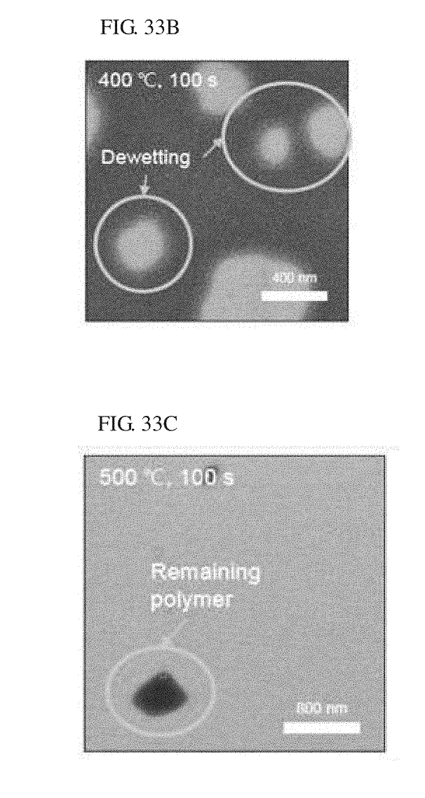

As illustrated in FIGS. 33A, 33B, and 33C, it may be confirmed that as an annealing temperature was increased, the block copolymer was damaged, and at 500° C., the block copolymer was mostly carbonized and removed, such that only a modified piece partially remained.

Hereinabove, although the present invention has been described by specific matters and exemplary embodiments, they have been provided only for assisting in the entire understanding of the present invention. Therefore, the present invention is not limited to the exemplary embodiments. Various modifications and changes may be made by those skilled in the art to which the present invention pertains from this description.

Therefore, the spirit of the present invention should not be limited to these exemplary embodiments, but the claims and all of modifications equal or equivalent to the claims are intended to fall within the scope and spirit of the present invention.

1. A method for manufacturing a nano-pattern, the method comprising: increasing a temperature of a self-assembling material applied on a substrate through light irradiation to form a self-assembly pattern.

2. The method of claim 1, wherein directed self-assembly is induced after a complete disordered state is made by inducing χN (here, χ is a Flory-Huggins interaction parameter, and N is a degree of polymerization of a polymer in the self-assembling material) of the self-assembling material to be 10.5 or less in a region irradiated with light.

3. The method of claim 2, wherein the light includes laser light.

4. The method of claim 2, wherein the light is irradiated to the self-assembling material in a three-dimensional movement of a light source.

5. The method of claim 4, wherein the nano-pattern is formed by irradiating light while locally moving light.

6. The method of claim 2, wherein an energy density of the light is 0.001 to 200,000 W/mm².

7. The method of claim 2, wherein a light scan velocity is 0.001 nm/s to 100 cm/s.

8. The method of claim 2, wherein a width of a light spot is 10 nm or more.

9. The method of claim 2, wherein the self-assembling material satisfies the following Correlation Equation 1 while the light is irradiated:
0.8×T_{ODT}≦T₁≦3.0×T_{ODT} [Correlation Equation 1]
(in Correlation Equation 1, T₁ is a temperature (° C.) of the self-assembling material, and T_{ODT} is an order-disorder phase transition temperature (° C.) of the self-assembling material).

10. The method of claim 2, wherein the self-assembling material in the region irradiated with light has a thermal gradient of 20 to 1,200° C./mm with respect to the self-assembling material in a region that is not irradiated with light.

11. The method of claim 2, wherein a temperature of the substrate positioned below the region irradiated with light is 50 to 500° C.

12. The method of claim 1, wherein the increasing of the temperature further includes performing thermal annealing.

13. The method of claim 1, wherein the self-assembly pattern is formed by irradiating light using a flash lamp annealing (FLA) type lamp.

14. The method of claim 13, wherein χN (here, χ is a Flory-Huggins interaction parameter, and N is a degree of polymerization of a polymer in the self-assembling material) of the self-assembling material at 600° C. is 18 to 50.

15. The method of claim 13, wherein the light irradiation is performed for 1 second or less.

16. The method of claim 13, wherein a temperature of the self-assembling material is heated to 400° C. or more by the light irradiation.

17. The method of claim 13, wherein the flash lamp annealing (FLA) type lamp is a xenon flash lamp.

18. The method of claim 1, wherein the self-assembling material is made of a polymer alone, or
a mixture of polymer and any one or two or more selected from an organic compound including any one or two or more selected from a liquid crystal forming compound, an organic semiconductor compound, and an organic photoelectronic compound; a conjugated polymer including any one or more selected from a liquid crystal forming polymer, an organic semiconductor polymer, and an organic photoelectronic polymer; and a reducing agent of Flory-Huggins interaction parameter (χ).

19. The method of claim 1, wherein the substrate further includes a photothermal conversion layer formed on the substrate.

20. The method of claim 19, wherein the photothermal conversion layer contains any one or two or more selected from graphene, graphene oxide, reduced graphene oxide, carbon nanotube, carbon black, amorphous carbon, a metal thin film, a metal oxide thin film, and a transition metal chalcogenide thin film.

21. The method of claim 19, wherein the photothermal conversion layer is provided on a surface of a two-dimensional or three-dimensional substrate.
